(19) United States
(12) Patent Application Publication
(10) Pub. No.: US 2012/0091229 A1
(43) Pub. Date: Apr. 19, 2012

(54) MANUAL PUMP TYPE FLUID DISPENSER

(75) Inventors: Keith Laidler, West Midlands (DE); Timothy Rodd, Hampshire (GB)

(73) Assignee: Leafgreen, Ltd., Wollaston, Stourbridge, West Midlands (GB)

(21) Appl. No.: 13/147,580

(22) PCT Filed: Feb. 4, 2010
(86) PCT No.: PCT/GB10/50179

§ 371 Date: Nov. 28, 2011

(30) Foreign Application Priority Data
Feb. 5, 2009 (GB) 0901907.6
Apr. 22, 2009 (GB) PCT/GB2009/001028
Apr. 22, 2009 (GB) PCT/GB2009/001029

(51) Int. Cl. A62C 11/00; B67D 7/76; G01F 11/00; B65D 37/00

(52) U.S. Cl. 239/330; 222/190; 222/207; 222/321.8; 222/383.1

(57) ABSTRACT

A manual pump fluid dispenser has a base (112) and a dispensing cap (114) with a dispenser outlet (144′) mounted to the base. Insert (116) is mounted between the base and the cap to define at least one pump chamber (122, 123). The insert engages with the base to define an inlet through which a liquid can be drawn into the at least one pump chamber from a liquid source. The insert has a central core (176) and a resiliently flexible upper diaphragm member (184) projecting upwardly and radially outwardly from the core for contact with the cap to define the at least one pump chamber. The insert is movable between an initial resiliently biased configuration in which the volume of the at least one pump chamber (122, 123) is at a maximum and a deformed configuration in which the volume of the at least one pump chamber is at a minimum, in the deformed configuration, the upper diaphragm (184) is at least partially folded down about itself and/or the core. Other aspects of the dispenser are described and claimed.

The present invention relates to manually actuated pump type fluid dispensers. The invention also relates to a method of manufacturing manual pump type fluid dispensers.

Manually actuated pump type fluid dispensers are commonly used to provide a means by which fluids can be dispensed from a non-pressurised container. Typically, dispensers of this kind have a pump arrangement which is located above the container when in use. The pump includes a pump chamber connected with the container by means of an inlet having an inlet valve and with a dispensing outlet via an outlet valve. To actuate the dispenser, a user manually applies a force to an actuator to reduce the volume of the pump chamber and pressurise the fluid inside. Once the pressure in the chamber reaches a pre-determined value, the outlet valve opens and the fluid is expelled through the outlet. When the user removes the actuating force, the volume of the chamber increases and the pressure in the chamber falls. This closes the outlet valve and draws a further charge of fluid up into the chamber through the inlet. A range of fluids can be dispensed this way this way including pastes, gels, liquid foams and liquids. In certain applications, the fluid is dispensed in the form of an atomised spray, in which case the outlet will comprise an atomising nozzle. The actuator may be push button or cap, though in some applications the actuator arrangement includes a trigger that can be pulled by a user's fingers.

A large number of commercial products are presented to consumers in a manual pump type dispenser, including, for example, tooth paste, antiperspirant, deodorant, perfumes, air fresheners, antiseptics, paints, insecticides, polish, hair care products, pharmaceuticals, shaving gels and foams, water and lubricants.

There are a number of drawbacks associated with conventional pump-action dispensers. Firstly, many of the conventional devices tend to be extremely complex in design and typically comprise numerous different component parts. In some designs there are between 8 and 10 individual components, with 10 to 14 individual components being used in dispensers having a trigger actuator. As a consequence, these devices can be costly to manufacture due to the amount of material required to form the individual components and the assembly processes involved. Secondly, many of the conventional devices tend to be bulky (which again increases the raw material costs) and a proportion of this bulk is invariably disposed inside the container to which the device is attached. This creates a drawback in that the nozzle device takes up a proportion of the internal volume of the container, which can be a particular problem in small containers where the available space inside the container is limited. Finally, the size of the pump is also dictated to certain extent by the size of the container to which it is attached. Thus, the size of the pump is usually restricted in small containers, and especially small containers with narrow necks, and this limits the amount of pressure that can be generated by the pump as well as the volume of fluid that can be dispensed, and, for this reason, can be detrimental to the performance of the device.

Many of the products which are supplied in a manual pump action dispenser are high volume products that are very cost sensitive and there is constant pressure on the manufactures of dispensers to reduce manufacturing costs without adversely affecting the performance of the dispenser.

There is a desire for a manually actuated pump dispenser which is:

simpler in design;

utilises fewer components; and

is easy to operate and functions effectively.

In accordance with one aspect of the invention, there is provided a manual pump dispenser for dispensing a fluid, the dispenser comprising a base and a dispensing cap having a dispenser outlet mounted to the base, the dispenser further comprising an insert mountable between the base and the cap to define at least one pump chamber between itself and the cap, the insert being adapted to engage with the base to define an inlet through which a liquid can be drawn into the at least one pump chamber from a liquid source, in which the insert comprises a central core and a resiliently flexible upper diaphragm member projecting upwardly and generally radially outwardly from the core for contact with the cap to at least partially define the at least one pump chamber within the cap, the insert being movable between an initial resiliently biased configuration in which the volume of the at least one pump chamber is at a maximum and a deformed configuration in which the volume of the at least one pump chamber is at a minimum, in the deformed configuration, the upper diaphragm being at least partially folded down about itself and/or the core.

The cap may comprise a shaped upper wall which defines part of a pump chamber in combination with the upper diaphragm, the upper diaphragm being configured such that when it is in the deformed configuration it conforms closely to the shape of the upper wall. The upper wall of the cap may be domed and the upper diaphragm may curve upwardly and generally radially outwardly from the central core. Alternatively, the upper wall of the cap may comprise a frusto-conical region and the upper diaphragm a corresponding frusto-conical region which extends upwardly and generally radially outwardly from the core.

The dispenser may comprise a trigger actuator for moving the insert between the initial resiliently biased and deformed configurations. In one embodiment, the trigger actuator is engageable with the insert to move the insert within the cap from its initial resiliently biased configuration to its deformed configuration. In this embodiment, the insert may have a lower diaphragm member projecting generally radially outwardly from the core below the upper diaphragm and a flexible member for mounting to the base to define the inlet, the trigger actuator being configured to engage the lower diaphragm member and the flexible member being configured to accommodate movement of the insert relative to the base. The core may project below the lower diaphragm and the flexible member may be located on a lower end of the core. The insert may be moulded from a combination of relatively rigid and relatively flexibly polymeric materials, at least part of the core being formed from a relatively rigid material, the upper and lower diaphragms and the flexible member being formed from one or more relatively flexible polymeric materials over moulded onto the core.

The insert may comprise an integral dip tube.

The insert may comprise an integral bag for containing a liquid.

The base may be part of a container for a liquid to be dispensed. In which case, the base may comprise a neck region of the container.

Alternatively, the base may be adapted to be mounted to the neck region of a container for a liquid to be dispensed.

A fluid passage may be defined through the core along which liquid can flow to enter the at least one pump chamber from a liquid source. A one way inlet valve may be formed integrally as part of the insert to admit liquid into the at least one pump chamber from the fluid passage when the pressure in the pump chamber is below the pressure of the liquid in the passageway.

The insert may have a lower diaphragm member projecting generally radially outwardly from the core for contact with the cap to at least partially define a pump chamber within the cap between itself and the upper diaphragm member, such that the volume of the pump chamber is at a maximum when the insert is in the initial configuration and at a minimum when the insert is in the deformed configuration. The insert may define at least two pump chambers inside the cap, a first pump chamber being defined between the upper diaphragm member and a closed upper end region of the cap and a second pump chamber being defined between the upper and lower diaphragm members and a side wall region of the cap, one of the first and second chambers comprising the at least one pump chamber and the other of the first and second chambers comprising a further pump chamber, the cap having an outlet passage arrangement for fluidly connecting each of the two pump chambers with the dispenser outlet.

Where the insert defines two pump chambers, the dispenser may include an air inlet arrangement by means of which ambient air can be drawn into the further chamber when the insert recovers from its deformed configuration to its initial configuration, the cap having an outlet passage arrangement for fluidly connecting each of the two pump chambers with the dispenser outlet.

Where the insert defines two pump chambers, the cap may include an outlet passage arrangement having a first outlet passage for connecting the at least one pump chamber with the dispenser outlet and a second outlet passage for connecting the further pump chamber with the dispenser outlet. The first and second outlet passages may be joined together upstream of the dispenser outlet so that, in use, the fluid from the further chamber and liquid from the at least one chamber are caused to mix before passing through the dispenser outlet. The first and second outlet passages may be joined at a swirl chamber upstream from the dispenser outlet. Where the dispenser has an air inlet arrangement for admitting ambient air into the further pump chamber, the dispenser may comprise a pre-compression valve for controlling the flow of liquid through the first outlet passage, the pre-compression valve being configured to open to allow liquid to flow from the at least one pump chamber to the dispenser outlet only when the pressure of the liquid in the at least one pump chamber is at or above a pre-determined threshold value, the outlet arrangement being arranged such that in use, the ratio of air to liquid dispensed varies over the course of a spray cycle. The outlet arrangement may be arranged such that the ratio of air to liquid dispensed is higher during at least one of an initial and an end phase of the spray cycle than during a main phase of the spray cycle. The outlet arrangement may be arranged such that the ratio of air to liquid dispensed is higher during both the initial and end phases of the spray cycle than during a main phase. The first and second outlet passages may be fluidly connected so that in use the pressure of the liquid flowing from the at least one pump chamber to the dispenser outlet limits the flow of air from the further pump chamber to the dispenser outlet. In one embodiment, no-pre-compression valve is provided to control the flow of air from the further pump chamber to the dispenser outlet. A one-way valve may be provided to prevent liquid flowing along the second outlet passage into the further pump chamber. The dispenser may include a spray nozzle and a trigger type actuator and may be configured to deliver a continuous spray for a period in excess of 1 second. In particular, the dispenser may be configured to deliver a continuous spray for a period in the range of 1 to 10 seconds, and more particularly for a period of 4 to 10 seconds, and even more particularly for a period of 6 to 10 seconds.

Where the insert defines two pump chambers in the cap, the dispenser may include an air inlet arrangement for drawing a quantity of ambient air into the at least one pump chamber together with the liquid when the insert recovers from its deformed configuration to its initial configuration.

The dispenser outlet may comprise a nozzle adapted so that liquid dispensed through the nozzle under pressure forms a spray.

An outlet passage connecting the at least one pump chamber with the dispenser outlet may be defined within the cap, and the insert may have an integral, resiliently flexible valve member which is resiliently biased into contact with a surface of the cap to prevent liquid flowing along the outlet passage to the dispenser outlet, the flexible valve member comprising a resiliently deformable flap having an enlarged end region for contact with the surface of the cap. The portion of the enlarged end region which contacts the surface of the cap may have a curved outer profile. The cap may comprise two spaced wall members which define between them an annular channel forming part of the outlet passage, in which case the enlarged end region of the flexible valve member may be resiliently biased into engagement with one of the wall members. An outlet for the at least one pump chamber may be defined in the cap to fluidly connect the at least one pump chamber with the annular passage on one side of the valve member such that, in use, the pressure of the liquid in the at least one pump chamber and the outlet when the dispenser is actuated reacts against the valve member tending to move the valve member against the resilient bias force so that the enlarged end is displaced away from the surface to open a flow path to the dispenser outlet, and the arrangement may be such that the valve member is only moved sufficiently to open a flow path when the pressure of the liquid in the at least one pump chamber and the outlet is at or above a threshold value. The enlarged end region may be resiliently compressible and the valve member may be configured so that the enlarged end region is compressed against the surface when the valve member is in a fully engaged position. In one embodiment, the valve flap can be moved from the fully engaged position in a direction away from the surface by a limited distance before the enlarged end region loses contact with the surface to open the flow path. The valve member may be annular.

In one embodiment, the base is annular and comprises or is adapted to be mounted to an annular neck forming an outlet of a container for a liquid to be dispensed, the insert having a second diaphragm member which projects generally radially outwardly from the core, the second diaphragm member including an integral, resiliently flexible inner seal which is resiliently biased against an inner surface of the base to form a liquid tight seal to prevent liquid from leaking out of the base past the insert in use, the inner seal member being capable of being deflected away from the inner surface of the base permit air to flow in an inward direction past the inner seal when the pressure of the ambient air acting on an outer side of the inner seal is greater than the pressure acting on the inner side of the inner seal member by a threshold amount in use, the second diaphragm member including an outer seal member which locates about an outer surface of the base, the dispenser having a twist lock arrangement operative such that the cap can be twisted relative to the base between a locked position in which actuation of the dispenser is disabled and a released position in which the dispenser can be actuated, the cap and the base having corresponding formations which co-operate to move the cap axially relative to the base when it is twisted between the locked and released positions, the cap having a further formation which compresses the outer seal member against the outer surface of the base to form a liquid and air tight seal between the outer seal member and the base when the cap is in the locked position, the air tight seal being released when the cap is in the unlocked position. The base may have a flange portion of reduced outer diameter at one end, the outer seal engaging with an outer diameter surface of the flange portion. The flange may comprise an under cut lip, the outer seal member having an annular lip on its inner surface which engages in the undercut. The cap may have an annular wall member which surrounds the outer seal member and the further formation may be a region of the annular wall of increased thickness. An ridge may be provided about an outer surface of the outer seal member which is contacted by the further formation.

In one embodiment, the dispenser is adapted to dispense a liquid as a foam, the cap defining an outlet passage arrangement fluidly connecting the at least one pump chamber to the dispenser outlet, the passage arrangement comprising an inlet for directing the liquid from one part of the outlet passage arrangement into an expansion chamber forming a further part of the passage arrangement, the expansion chamber having a larger cross-sectional area than the inlet, in which the inlet is configured so that the liquid is formed into a thin sheet or fan on entry into the expansion chamber. In one arrangement, the inlet comprises at least one orifice for directing the liquid into the expansion chamber and at least one corresponding formation on to which the liquid passing through the orifice is directed inside the expansion chamber, the formation being shaped to deflect the liquid through an angle in the range of 60° to 120°, and more preferably in the range of 80° to 110°, from its direction of travel through the orifice. The formation may comprise a curved ramp surface whose surface may be smooth or textured. The ramp surface may define a curved channel. The formation may be flexible so that it is capable of movement under the pressure of the liquid being directed on to it in use. The expansion chamber may be in the form of an elongate fluid passage and the orifice may direct the liquid into the expansion chamber in a lateral or an axial direction of the chamber. In an alternative arrangement, the inlet includes a fluid passage for directing the liquid into the expansion chamber, the inlet fluid passage having a conically divergent outlet region, the inlet further comprising a flow divider located centrally in the outlet region, such that a frusto-conical fluid channel is defined between the flow divider and the surface of the divergent region of the inlet fluid passage. The flow divider may have a conical region which locates within the divergent region, the outer surface of the conical region of the flow divider being spaced from the surface of the divergent region of the inlet fluid passage. The flow divider may be suspended within the inlet fluid passage by means of two or more links, the links being spaced so that fluid flow channels are provided between the links through which the liquid flowing through the frusto-conical fluid channel can pass. The flow divider may be an integral part of the cap. In either arrangement, filter means may be provided in the expansion chamber to refine foam produced in the expansion chamber. The filter means may comprise two or more spaced mesh screens. The insert may define at least one further pump chamber in the cap, the at least one further pump chamber being configured to dispense air, the cap defining an air outlet passage arrangement for directing air from the further pump chamber into the expansion chamber to mix with the liquid. Where the expansion chamber is in the form of an elongate fluid passage, the air outlet passage arrangement may comprise one or more orifices for directing air into the expansion chamber in a longitudinal or axial direction of the chamber.

In accordance with a second aspect of the invention, there is provided a manual pump dispenser for dispensing a liquid product, the dispenser comprising a pump chamber for receiving the liquid product from a liquid source and an outlet through which the liquid product is dispensed from the pump chamber, the dispenser further comprising a reservoir for holding a volume of water and means for introducing water from the reservoir into the liquid product in at least one of the pump chamber and an outlet passage connecting the pump chamber with the outlet. The reservoir may have a removable closure to enable the reservoir to be periodically re-filled. The dispenser may be a foam dispenser.

In accordance with a third aspect of the invention, there is provided a manual pump dispenser comprising a container for a liquid to be dispensed, the container having an annular neck forming an outlet for the container, a pump arrangement including at least one pump chamber mounted to the container for dispensing the liquid in the container, the dispenser also comprising a closure member mounted to and closing the neck of the container, the closure member having a resiliently flexible inner seal which is resiliently biased against an inner surface of the neck to form a liquid tight seal to prevent liquid from leaking out of the container, the inner seal being capable of being deflected away from the inner surface of the neck to permit air to flow in an inward direction past the inner seal when the pressure inside the container is lower than the pressure of the ambient air acting on the inner seal by a threshold amount in use, the closure member including an outer seal which locates about an outer surface of the neck, the dispenser having collar, at least part of which locates about the neck of the container, and a twist lock arrangement operative such that the collar can be twisted relative to the neck between a locked position in which actuation of the dispenser is disabled and a released position in which the dispenser can be actuated, the collar and the container having corresponding formations which co-operate to move the collar axially relative to the neck when it is twisted between the locked and released positions, the collar having a further formation which compresses the outer seal member against the outer surface of the neck to form a liquid and air tight seal between the outer seal and the neck when the collar is in the locked position, the air tight seal being released when the collar is in the unlocked position.

The neck may have a flange portion of reduced outer diameter, the outer seal engaging with an outer surface of the flange portion. The flange may comprise an under cut lip, the outer seal having an annular lip on its inner surface which engages in the undercut. The collar may have an annular wall member which surrounds the outer seal and the further formation may comprise a region of the wall of increased thickness. An ridge may be provided about an outer surface of the outer seal which is contacted by the further formation. The collar may be part of an actuation cap of the dispenser pump arrangement.

In accordance with a fourth aspect of the invention, there is provided a manual pump dispenser for dispensing a liquid as a foam, the dispenser having a dispenser outlet, at least one pump mechanism including a pump chamber, and an outlet passage arrangement fluidly connecting the pump chamber to the dispenser outlet, the pump mechanism being operative to draw a liquid from a liquid reservoir into the pump chamber and to dispense the liquid from the chamber into the outlet passage arrangement under pressure when actuated, the outlet passage arrangement comprising an inlet through which the liquid product is directed from one part of the outlet passage arrangement into an expansion chamber forming a further part of the passage arrangement, the expansion chamber having a larger cross-sectional area than the inlet, in which the inlet is configured so that the liquid passing through the inlet in use is formed into a thin sheet on entry into the expansion chamber.

The inlet may comprise at least one orifice through which the liquid is directed into the expansion chamber and at least one corresponding formation on to which liquid passing through the orifice is directed inside the expansion chamber, the formation being shaped to deflect the liquid through an angle in the range of 60° to 120°, and more preferably in the range of 80° to 110°, from its direction of travel through the orifice. The formation may comprise a curved ramp surface whose surface may be smooth or textured. The ramp surface may define a curved channel to limit the width of the sheet the liquid is formed into in use. The formation may be flexible so that it is capable of movement under the pressure of the liquid being directed on to it in use. The expansion chamber may be in the form of an elongate fluid passage and the orifice may direct the liquid into the expansion chamber in a lateral or an axial direction of the chamber.

Alternatively, the inlet may comprise an inlet fluid passage for directing the liquid into the expansion chamber, the inlet fluid passage having a conically divergent outlet region, the inlet further comprising a flow divider located centrally in the outlet region, such that a frusto-conical fluid channel is defined between the flow divider and the surface of the divergent region of the inlet fluid passage. The flow divider may have a conical region which locates within the divergent region, the outer surface of the conical region of the flow divider being spaced from the surface of the divergent region of the inlet fluid passage. The flow divider may be suspended within the inlet fluid passage by means of two or more links, the links being spaced so that fluid flow channels are provided between the links through which the liquid flowing through the frusto-conical fluid channel can pass. The flow divider may be an integral part of the cap.

A filter arrangement may be provided in the expansion chamber to refine foam produced in the expansion chamber. The filter arrangement may comprise two or more spaced mesh screens.

The pump mechanism may comprise at least one further pump chamber for dispensing air, the outlet passage arrangement including an air outlet passage arrangement for directing air from the further pump chamber into the expansion chamber to mix with the liquid. Where the expansion chamber is in the form of an elongate fluid passage, the air outlet passage arrangement may comprise one or more orifices for directing air into the expansion chamber in an axial or longitudinal direction of the chamber.

In accordance with a fifth aspect of the invention, there is provided a manual pump dispenser comprising a pump chamber having an outlet, a dispenser outlet and a outlet passage connecting the pump chamber outlet with the dispenser outlet, the dispenser comprising a valve member for controlling the flow of liquid from the pump chamber outlet to the dispenser outlet, the valve member being resiliently biased into contact with a surface of the dispenser to prevent liquid flowing along the outlet passage to the dispenser outlet, in which the valve member comprises a resiliently deformable flap having an enlarged end region for contact with the surface.

The portion of the enlarged end region which contacts the surface may have a curved outer profile. The dispenser may comprise two spaced wall members which define between them an annular channel forming part of the outlet passage, the enlarged end region of the flexible valve member being resiliently biased into engagement with one of the wall members. The pump chamber outlet may fluidly connect the pump chamber with the annular passage on one side of the valve member such that, in use, the pressure of the liquid in the pump chamber and the outlet when the dispenser is actuated reacts against the valve member tending to move the valve member against the resilient bias force so that the enlarged end is displaced away from the surface to open a flow path to the dispenser outlet, the arrangement being such that the valve member is only moved sufficiently to open a flow path when the pressure of the liquid in the pump chamber and the outlet is at or above a threshold value. The valve flap may be configured so that in use it can be moved from the fully engaged position in a direction away from the surface by a distance before the enlarged end region loses contact with the surface to open the flow path.

The enlarged end region may be resiliently compressible, and the valve member may be configured so that the enlarged end region is compressed against the surface when the valve member is in a fully engaged position.

The valve member may be annular.

In accordance with a sixth aspect of the invention, there is provided a manual pump dispenser, the dispenser having a body comprising a base defining an outlet through which a liquid to be dispensed may be drawn from a liquid source and a dispenser cap mounted to the base, the dispenser cap having a dispenser outlet and defining a bore, the dispenser further comprising a pump member insert located in the bore to define at least two pump chambers within the cap, the pump member comprising a central core and having a closure member mounted to the base to close the outlet, the pump member having a resiliently flexible first diaphragm member projecting from the core for contact with the cap, a first pump chamber being defined between the first diaphragm member the cap and an end region of the cap, the pump member having a seal member projecting from the core in spaced relation to the first diaphragm member and the closure member, the seal member contacting a surface of the cap defining the bore, a second pump chamber being defined within the cap between the first diaphragm member and the seal member, the pump member being movable relative to the cap between an initial resiliently biased configuration in which the volume of the two pump chambers is at a maximum and a deformed configuration in which the volume of the two pump chambers is reduced, the dispenser further comprising a trigger actuator mounted to the body for movement between a released position and an actuated position, the trigger actuator having an abutment formation which contacts a corresponding abutment formation on the pump member to move the pump member from the initial resiliently biased configuration to the deformed configuration on movement of the trigger from the released position to the actuated position.

The base may be adapted to be mounted to an outlet of a container for a liquid to be dispensed. Alternatively, the base may comprise a container for a liquid to be dispensed, the container having an annular neck region which defines the outlet, the cap being mounted to the container about the neck region.

A fluid passage arrangement may be defined within the core for fluidly connecting at least one of the first and second pump chambers with a liquid source, the fluid passage arrangement having an inlet for fluid connection with a liquid source through the outlet. The fluid passage arrangement may be configured to fluidly connect the inlet to both the first and second pump chambers. Alternatively, the fluid passage arrangement may comprise two separate fluid passageways, each passageway for fluidly connecting a respective one of the first and second pump chambers with a liquid source and each fluid passageway having an inlet for fluid connection with a respective liquid source through the outlet.

The corresponding abutment formation on the pump member may comprise a rigid abutment surface projecting outwardly from core between the first diaphragm member and the closure member, the trigger having one or more projections for contact with rigid abutment surface. The seal member may be located about the rigid abutment surface.

The closure member may be flexible to accommodate movement of the pump member between the initial resiliently biased configuration and the deformed configuration. Alternatively or in addition, at least part of the core between the closure member and the corresponding abutment formation may be flexible to accommodate movement of the pump member between the initial resiliently biased configuration and the deformed configuration.

The pump member may have a rigid portion which defines at least part of the core and the corresponding abutment formation and resiliently flexible portions which define the first diaphragm member, the seal member and the closure member.

The dispenser may comprise an inlet arrangement including an inlet valve for admitting ambient air in to at least one of the pump chambers when the pressure in the chamber is below ambient air pressure by a predetermined amount.

The dispenser may be configured to dispense a liquid as foam, the dispenser including an outlet passageway arrangement in accordance with the fourth aspect of the invention.

The cap may comprise an outlet fluid passageway arrangement for fluidly connecting the first and second pump chambers with the dispenser outlet, the outlet passage arrangement including a first outlet passage for connecting the first pump chamber with the dispenser outlet and a second outlet passage for connecting the second pump chamber with the dispenser outlet. The first and second outlet passages may be joined together upstream of the dispenser outlet so that, in use, the fluids dispensed from the first and second pump chambers are caused to mix before passing through the dispenser outlet. The first and second outlet passages may be joined at a swirl chamber upstream from the dispenser outlet. One of the pump chambers may configured to dispense a liquid and the other air, the dispenser having an outlet arrangement having a spray nozzle and a pre-compression valve for controlling the flow of liquid from said one of the chambers, the pre-compression valve being configured to open to allow liquid to flow from said one of the pump chambers to the dispenser outlet only when the pressure of the liquid in said one of the pump chambers is at or above a pre-determined threshold value, the outlet arrangement being arranged such that in use, the ratio of air to liquid dispensed varies over the course of a spray cycle. The outlet arrangement may be arranged such that the ratio of air to liquid dispensed is higher during at least one of an initial and an end phase of the spray cycle than during a main phase of the spray cycle. The outlet arrangement may be arranged such that the ratio of air to liquid dispensed is higher during both the initial and end phases of the spray cycle than during a main phase. The first and second outlet passages may be fluidly connected so that in use the pressure of the liquid flowing from said one of the pump chambers to the dispenser outlet limits the flow of air from the other of the pump chambers to the dispenser outlet. In one embodiment, no-pre-compression valve is provided to control the flow of air from the other of the pump chambers to the dispenser outlet. A one-way valve may be provided to prevent liquid flowing from said one of the pump chambers to the other of the pump chambers. The dispenser may be configured to deliver a continuous spray for a period excess of 1 second. In particular, the dispenser may be configured to deliver a continuous spray for a period in the range of 1 to 10 seconds, and more particularly for a period of 4 to 10 seconds, and even more particularly for a period of 6 to 10 seconds.

The dispenser may comprise a pre-compression outlet valve arrangement in accordance with the fifth aspect of the invention.

A manual pump dispenser in accordance with any of the first, second, third fourth or fifth aspects of the invention may have a trigger actuator. The trigger actuator may be an integral part of the cap. The trigger actuator may be operatively connected such that movement of the trigger towards a central axis of the dispenser moves the insert from its initial resiliently biased configuration to its deformed configuration. The dispenser may be a foam or a spray dispenser.

Further aspects and features of the invention will be understood from the following description of a number of embodiments of the invention, which are provided by way of example only, with reference to the accompanying drawings, in which:

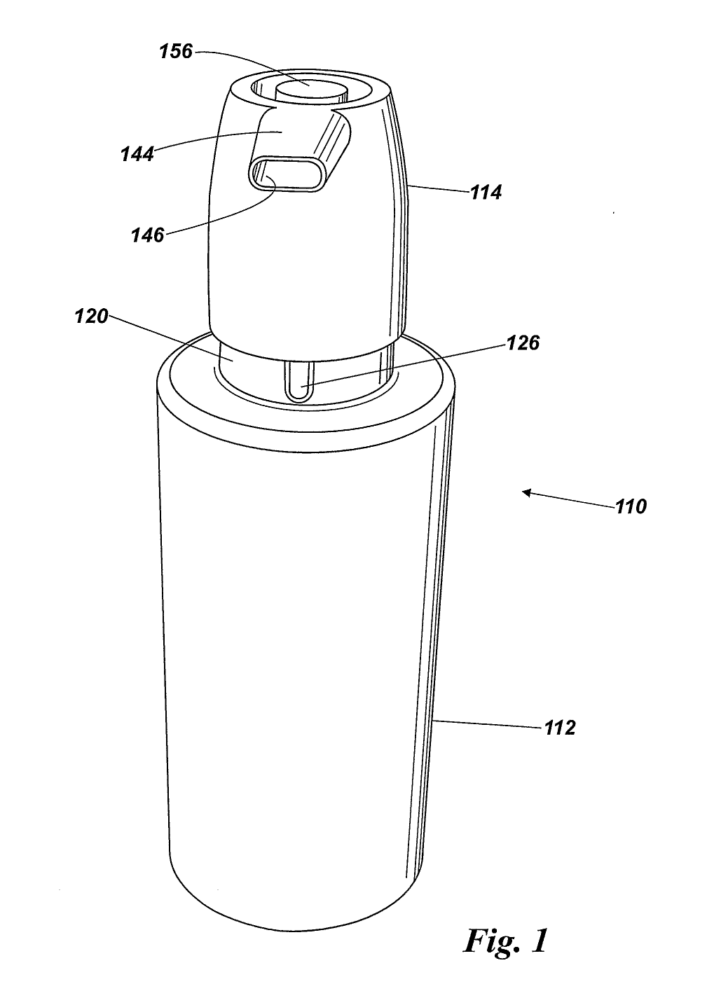

FIG. 1 is a perspective view of first embodiment of a dispenser in accordance with the invention, shown prior to actuation;

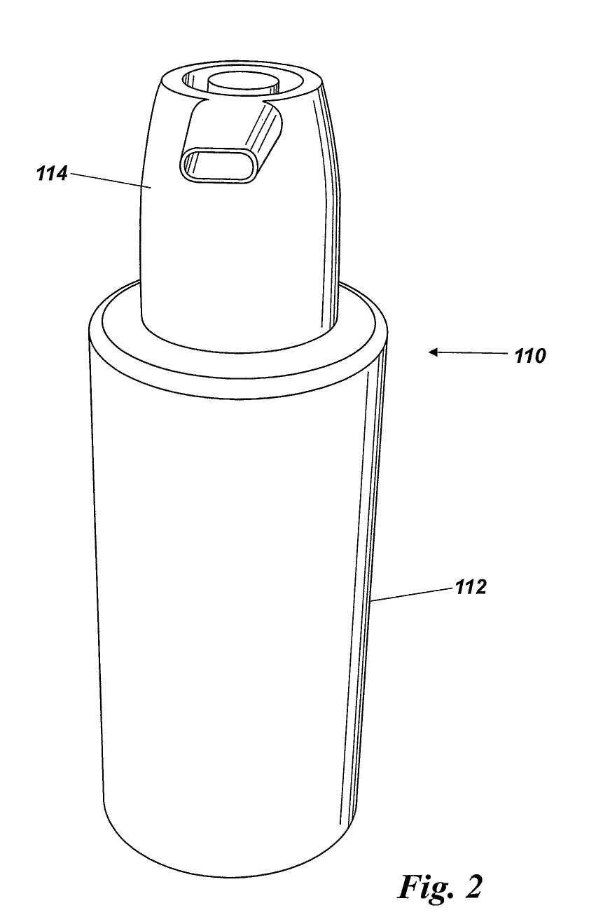

FIG. 2 is a view similar to that of FIG. 1 but showing the dispenser in mid-actuation with a cap portion depressed;

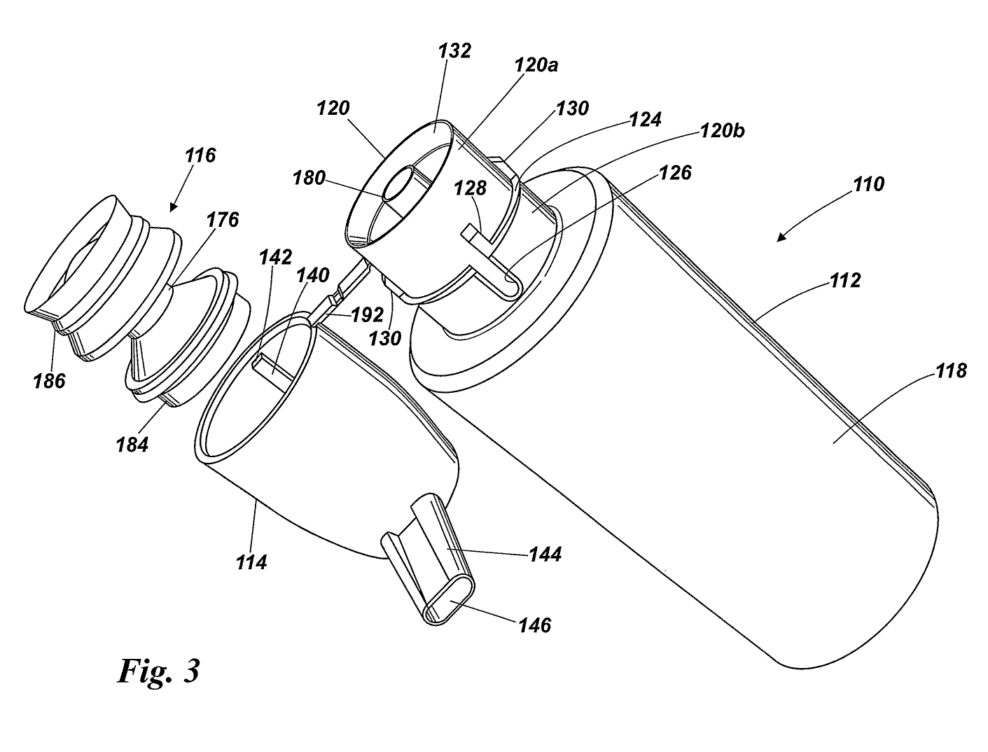

FIG. 3 is an exploded view of the dispenser of FIG. 1;

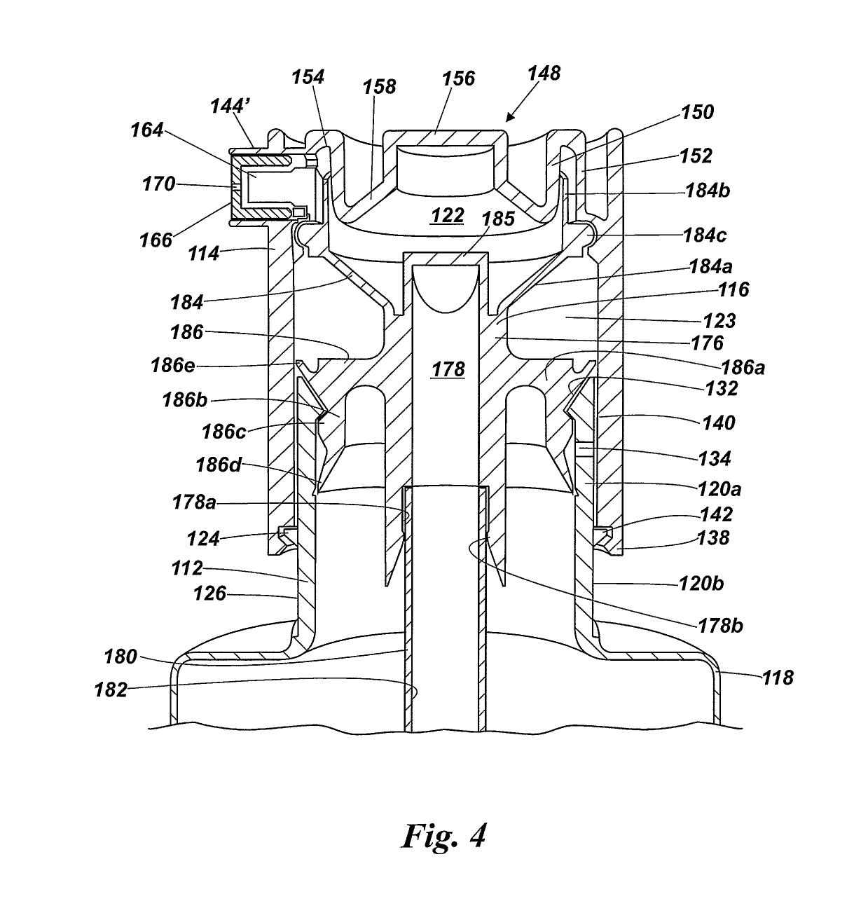

FIG. 4 is a cross-sectional view through part of the dispenser of FIG. 1 but showing an alternative outlet incorporating a spray nozzle;

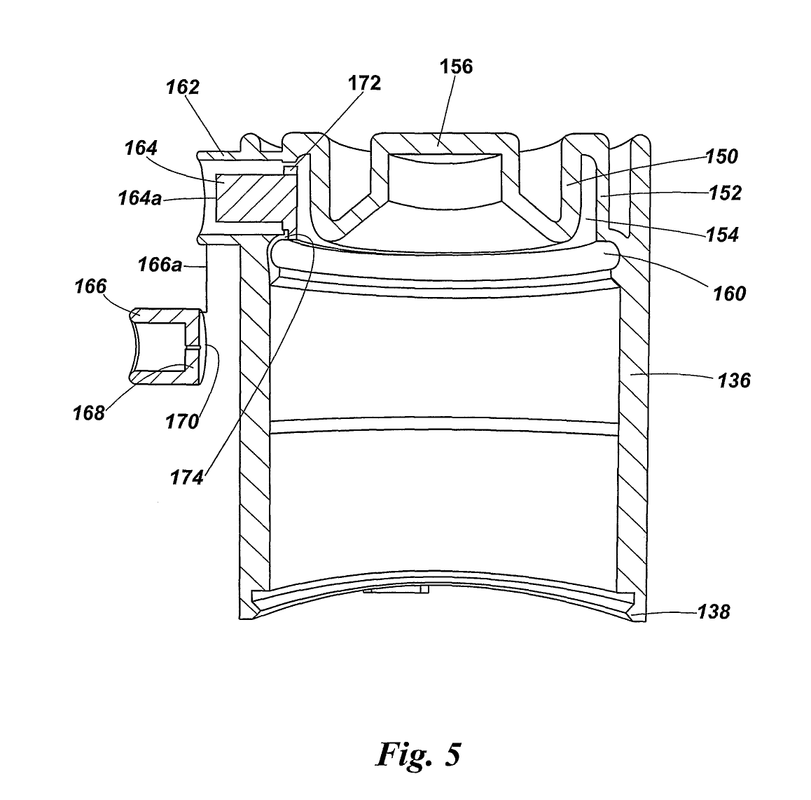

FIG. 5 is a cross-sectional view though a cap forming part of the dispenser of FIG. 4;

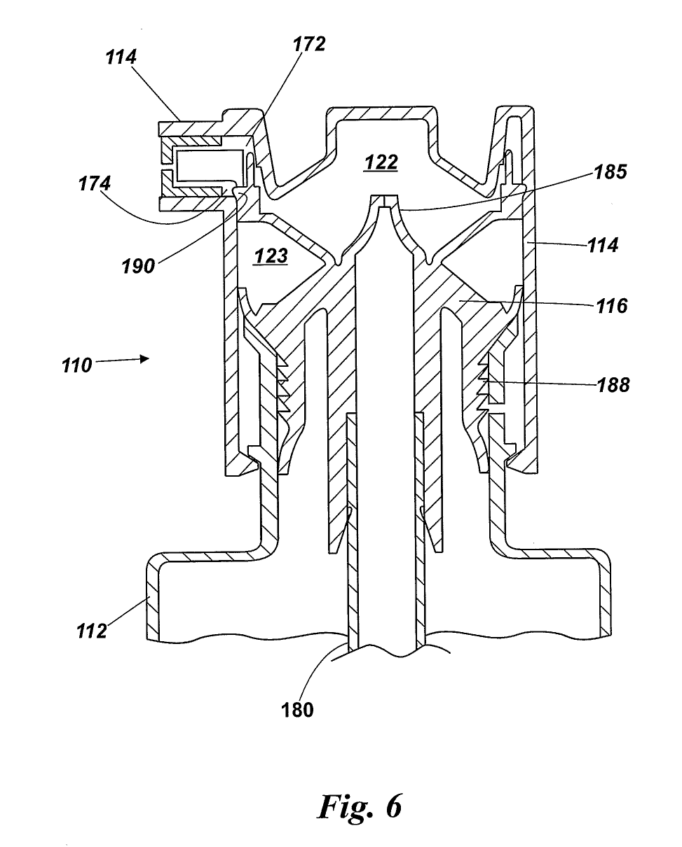

FIG. 6 is a cross-sectional view similar to that of FIG. 4 showing a modified form of the dispenser of FIG. 1 prior to actuation;

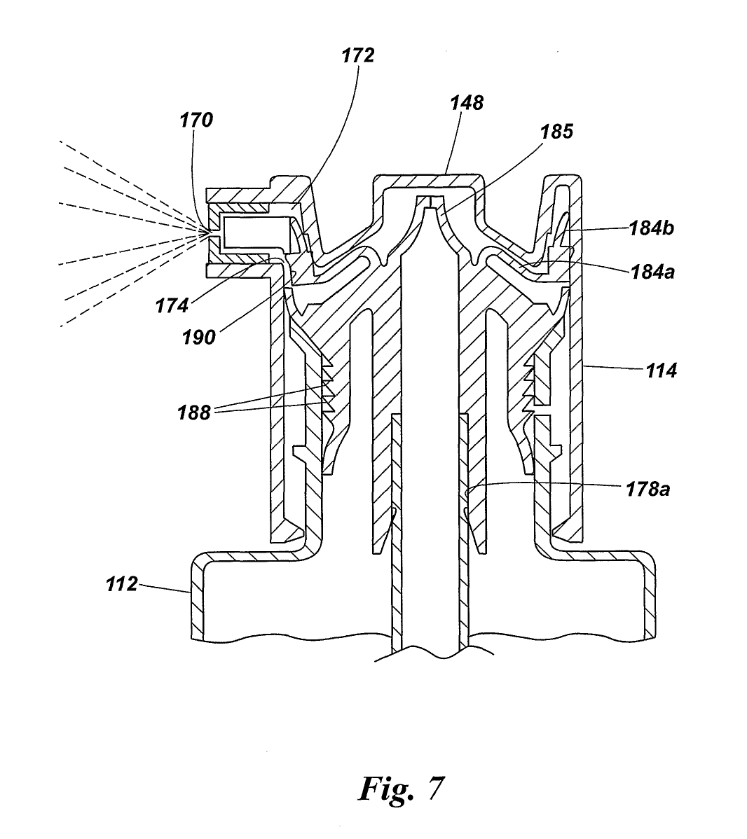

FIG. 7 is a view similar to that of FIG. 6 but showing the dispenser in mid-actuation;

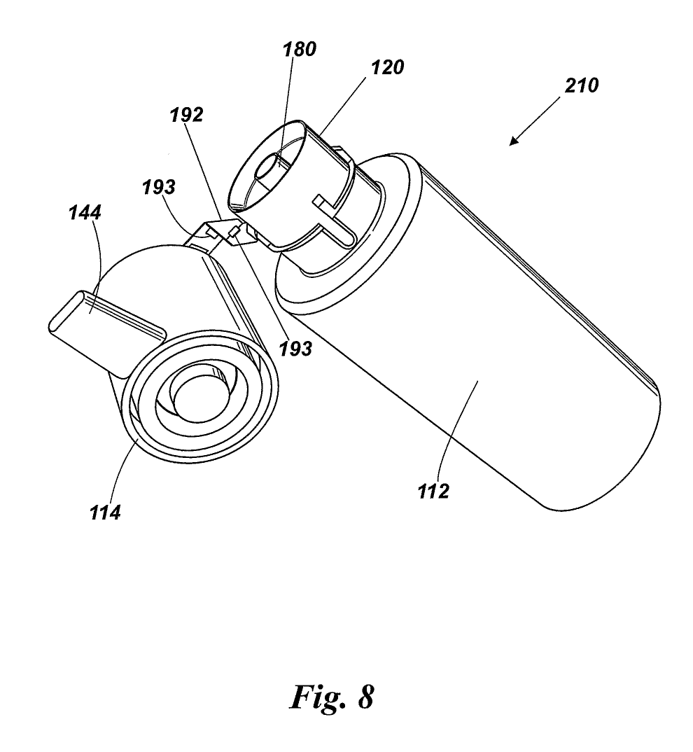

FIG. 8 is a perspective view of a further embodiment of a dispenser in accordance with the invention;

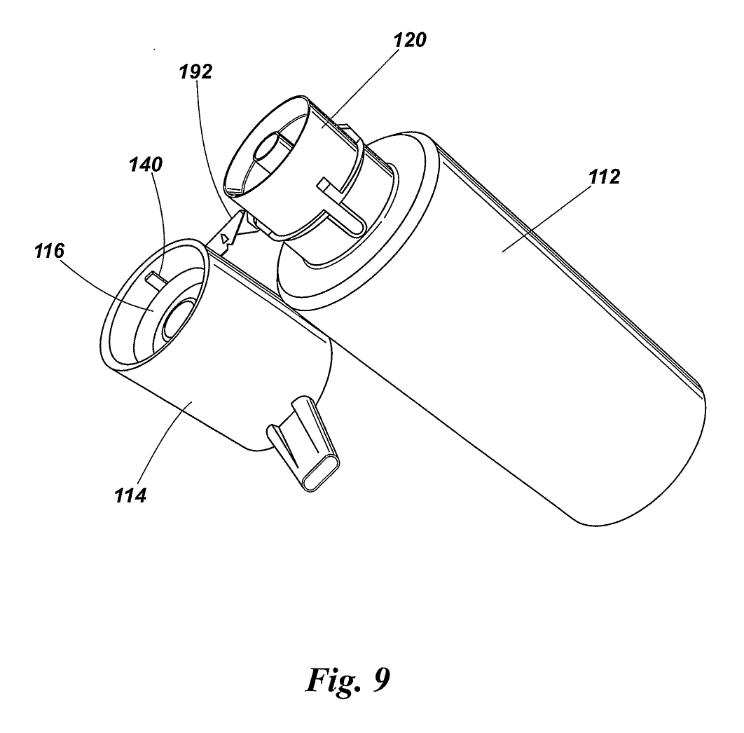

FIG. 9 is a view similar to that of FIG. 8 but showing the cap after insertion of a flexible insert;

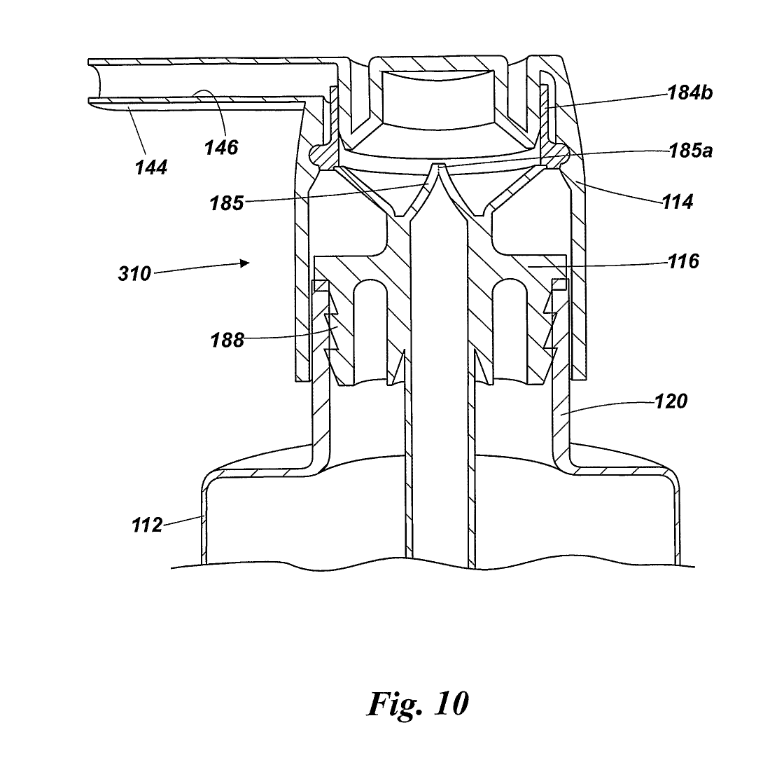

FIG. 10 is a view similar to that of FIG. 4 of a further alternative embodiment of a dispenser in accordance with the invention;

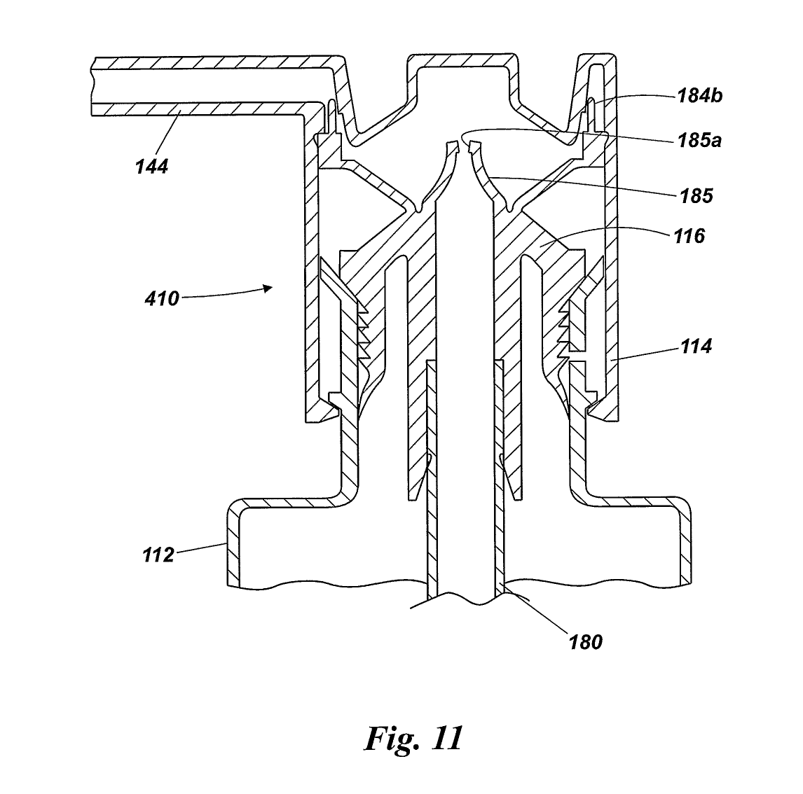

FIG. 11 is a view similar to that of FIG. 4, showing a further embodiment of a dispenser in accordance with the invention during a recovery phase with an inlet valve open;

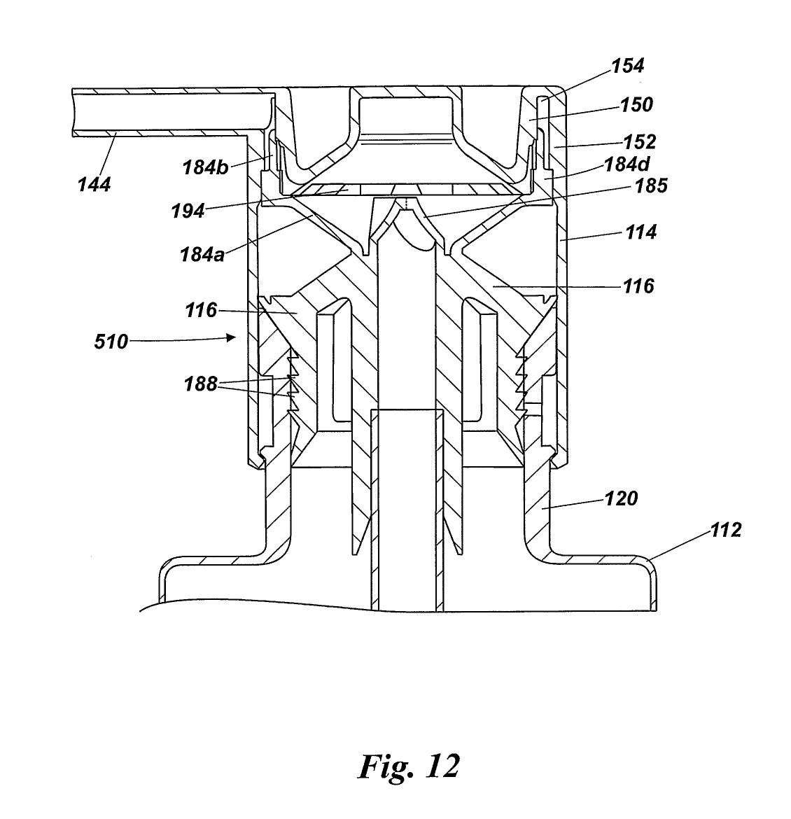

FIG. 12 is view similar to that of FIG. 4 of a yet further alternative embodiment of a dispenser in accordance with the invention;

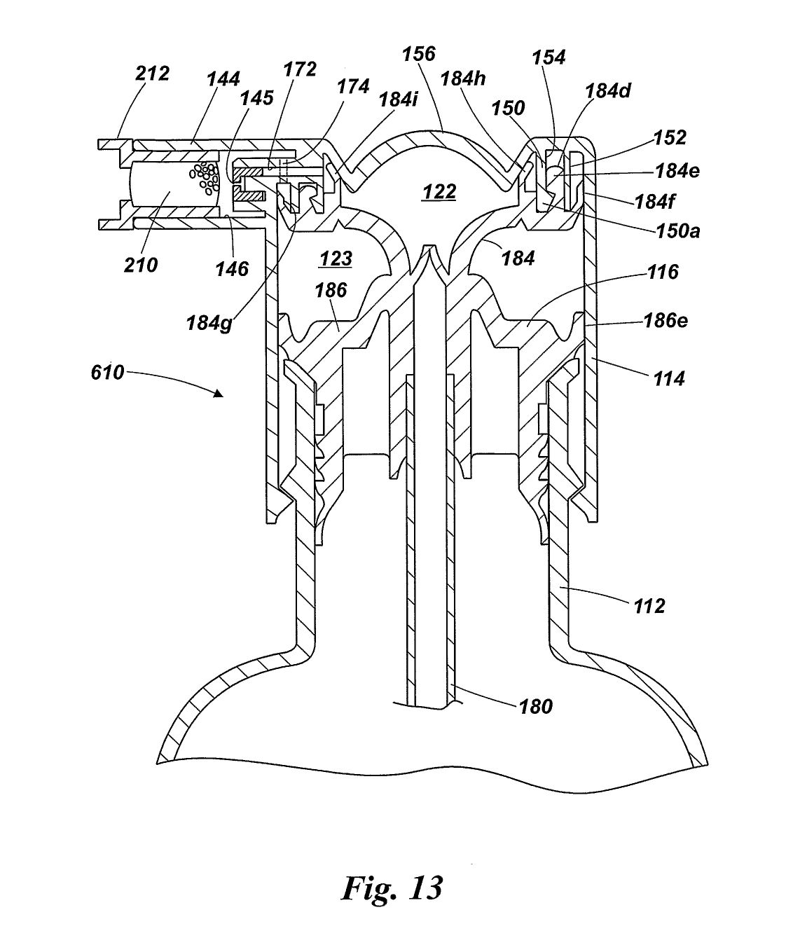

FIG. 13 is view similar to that of FIG. 4 of a still further alternative embodiment of a dispenser in accordance with the invention;

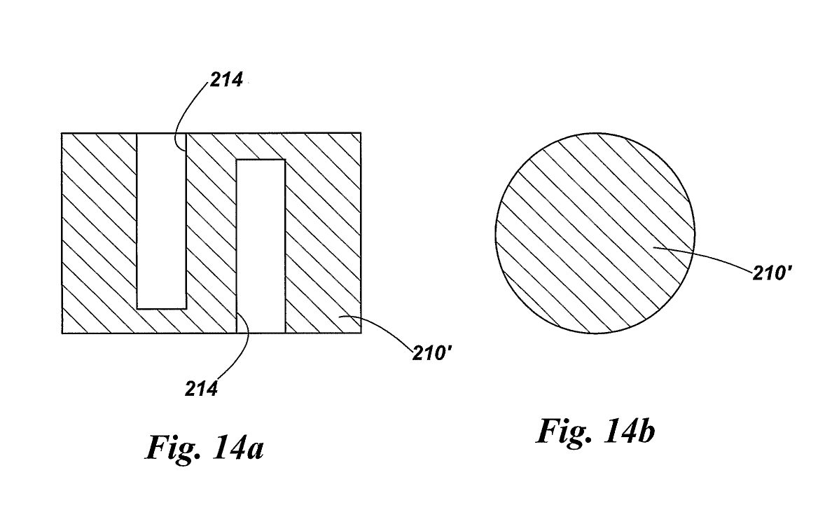

FIGS. 14a and 14b are longitudinal and lateral cross sectional views respectively through a modified filter plug suitable for use in a dispenser in accordance with the invention;

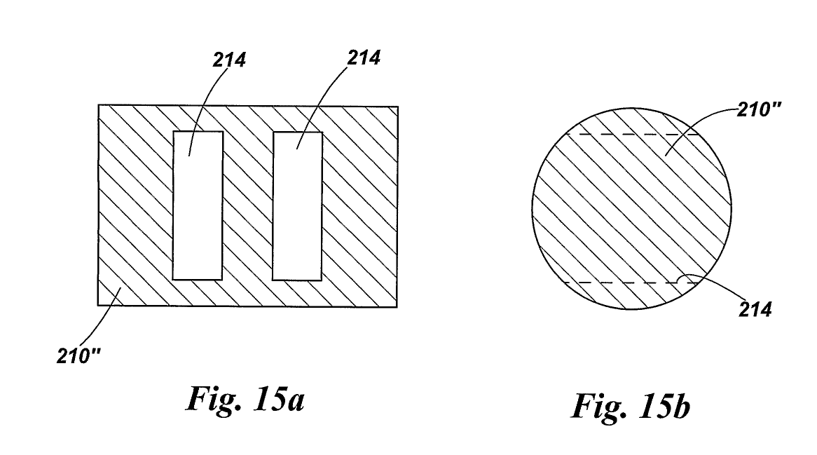

FIGS. 15a and 15b are longitudinal and lateral cross sectional views respectively through a further modified filter plug suitable for use in a dispenser in accordance with the invention;

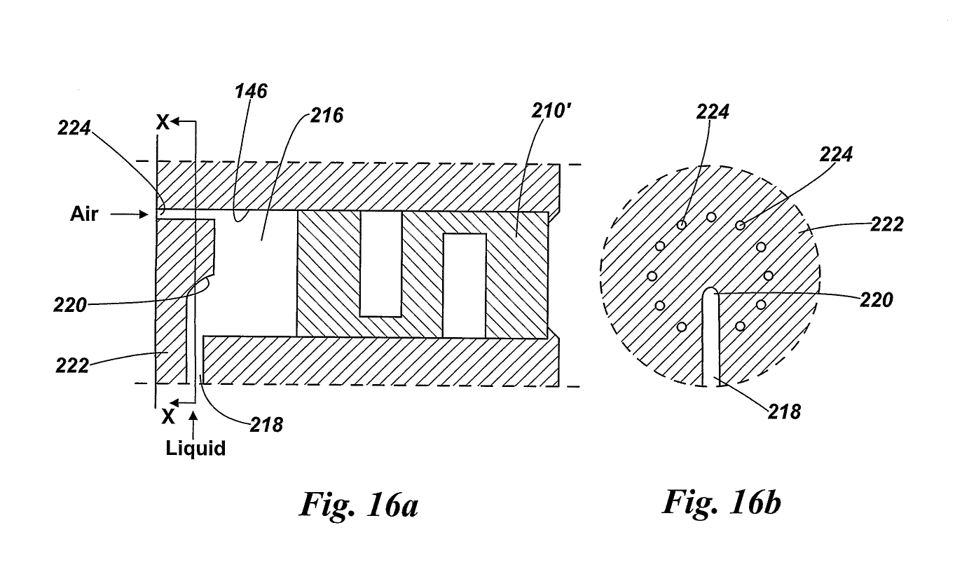

FIG. 16a is a longitudinal cross sectional view through an outlet arrangement for a dispenser in accordance with the invention adapted to produce foam;

FIG. 16b is a lateral cross sectional view through and end wall of the outlet arrangement of FIG. 16a taken on line X-X;

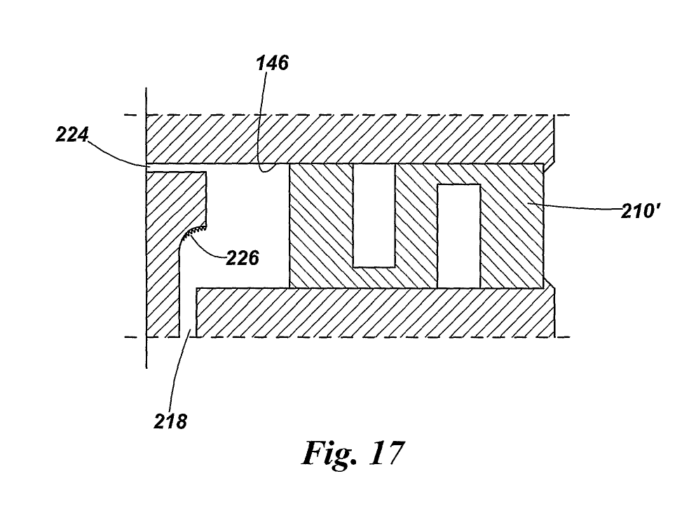

FIG. 17a is a longitudinal cross sectional view through a further embodiment of an outlet arrangement for a dispenser in accordance with the invention adapted to produce foam;

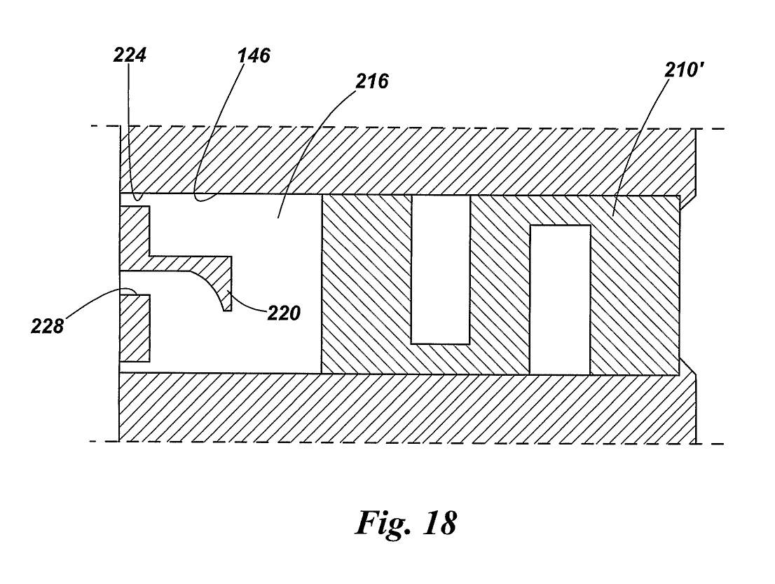

FIG. 18 is a longitudinal cross sectional view through a yet further embodiment of an outlet arrangement for a dispenser in accordance with the invention adapted to produce foam;

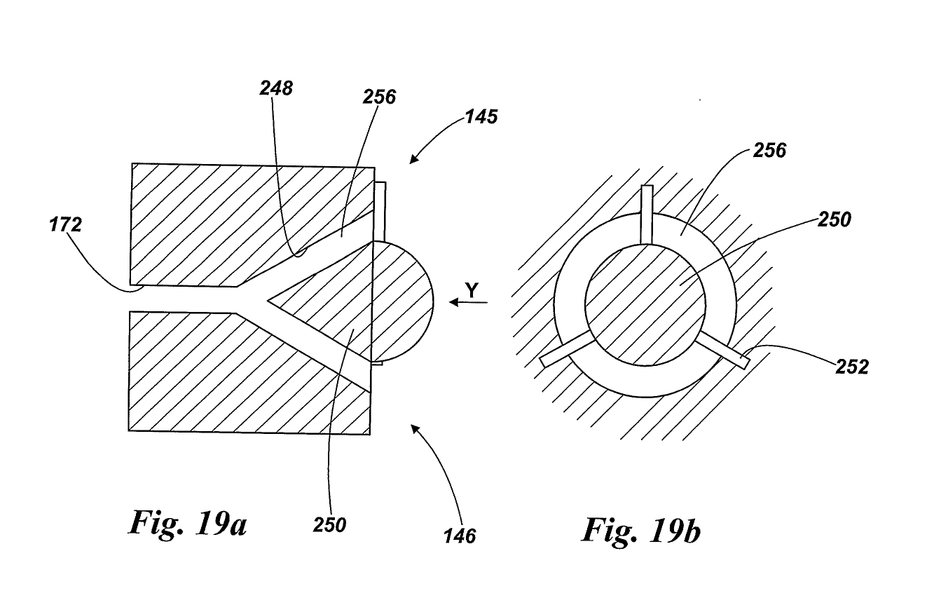

FIG. 19a is a longitudinal cross sectional view through a flood jet arrangement for use in an outlet passage of a dispenser in accordance with the invention;

FIG. 19b is an end view of the flood jet arrangement of FIG. 19a, taken in the direction of arrow Y;

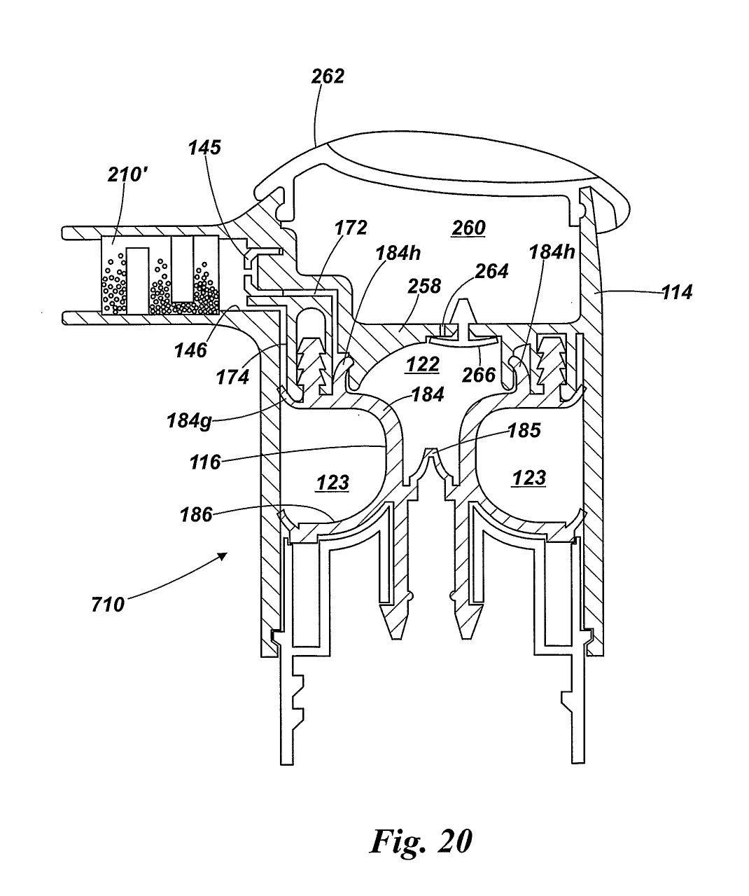

FIG. 20 is view similar to that of FIG. 4 of a yet further alternative embodiment of a dispenser in accordance with the invention;

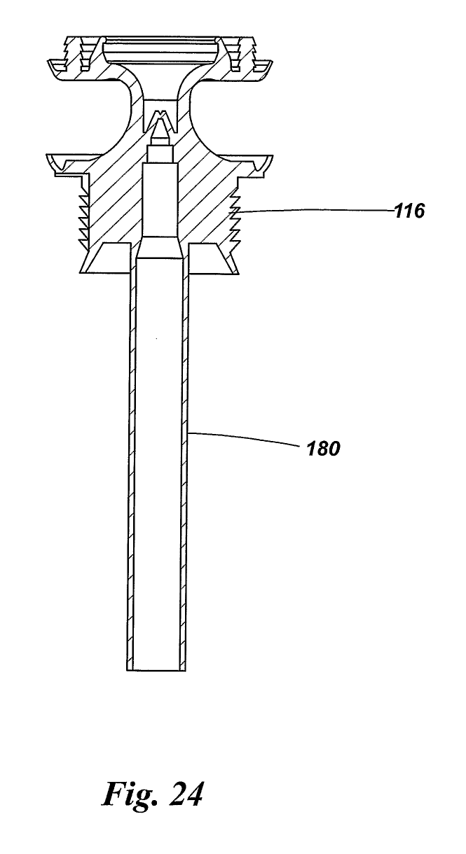

FIG. 24 is a cross sectional view through a modified insert for use in a dispenser in accordance with the invention;

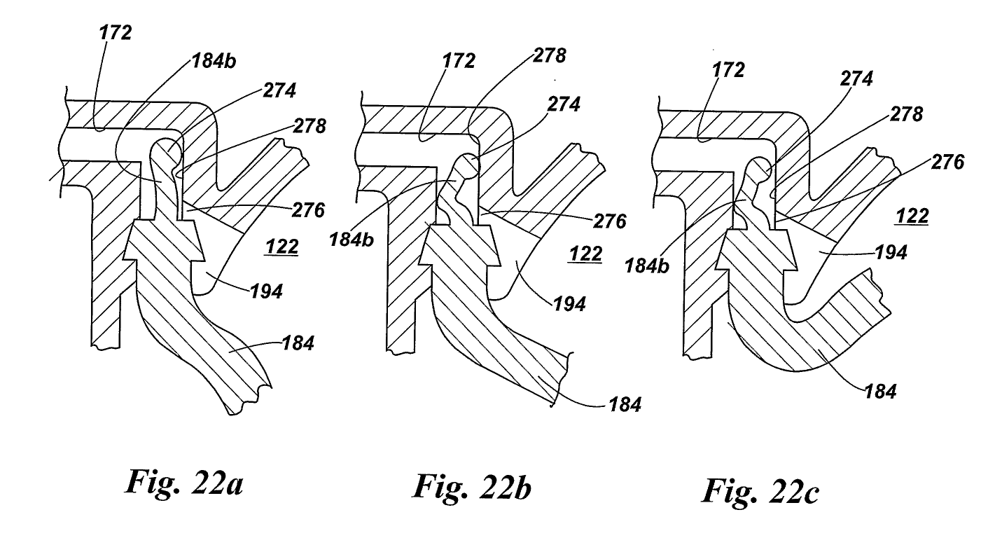

FIGS. 22a to 22c are a series of cross sectional views through an outlet valve arrangement for use in a dispenser in accordance with the invention illustrating movement of the valve as it opens during actuation of the dispenser;

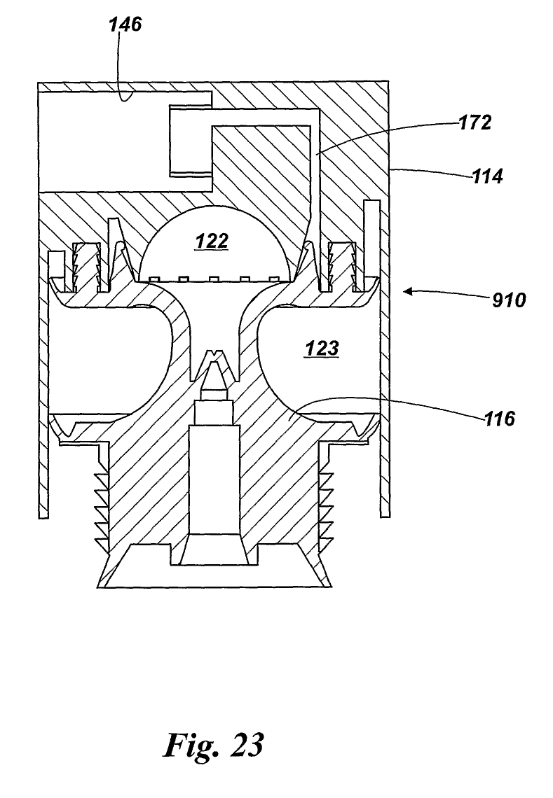

FIG. 23 is view similar to that of FIG. 4 of a yet further alternative embodiment of a dispenser in accordance with the invention;

FIG. 24 is a cross sectional view through a modified insert for use in a dispenser in accordance with the invention;

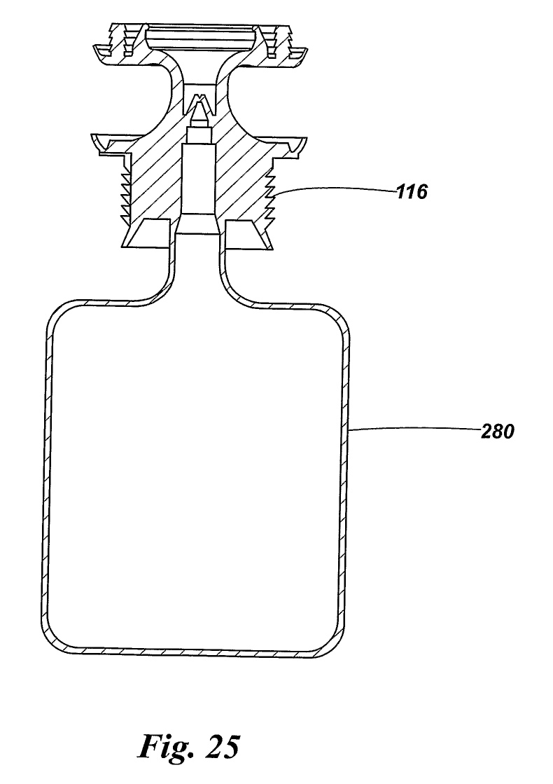

FIG. 25 is a cross sectional view through a further modified insert for use in a dispenser in accordance with the invention;

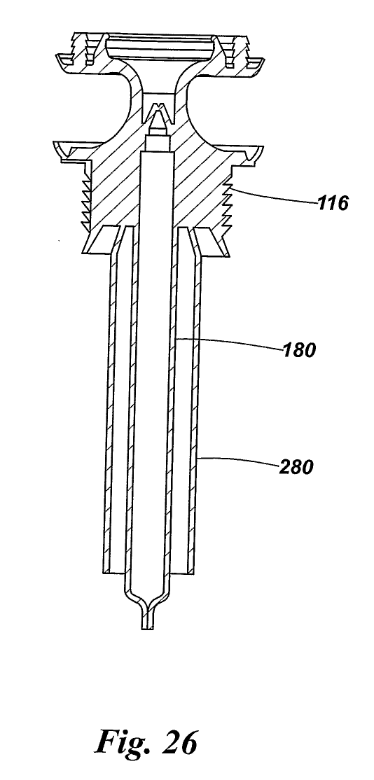

FIG. 26 is a cross sectional view through a still further modified insert for use in a dispenser in accordance with the invention;

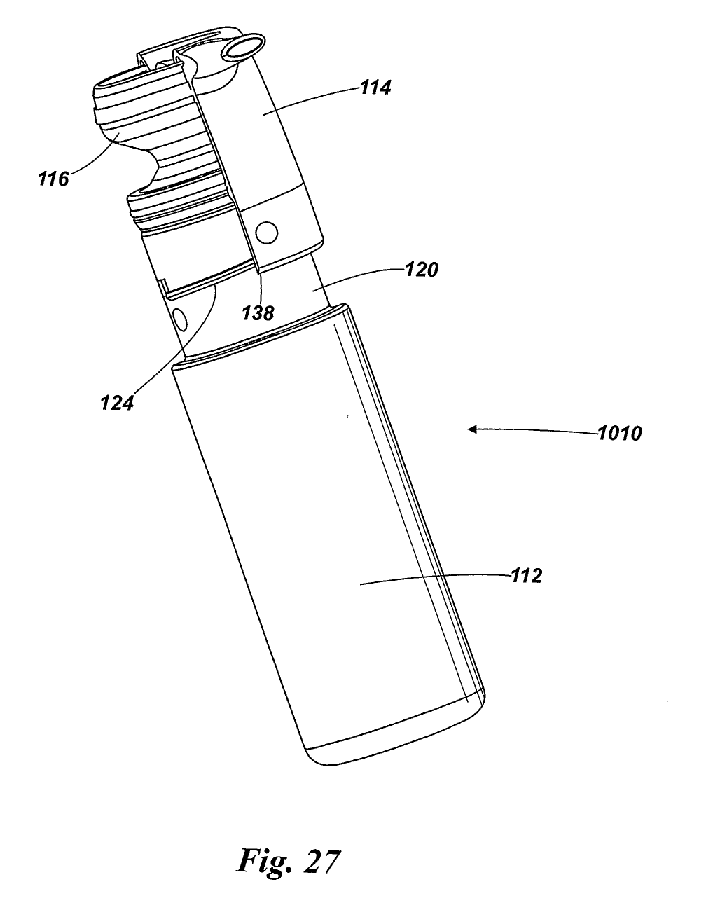

FIG. 27 is a perspective view of a further embodiment of a dispenser in accordance with the invention, part of an actuator cap being cut away to show details of a modified twist lock arrangement;

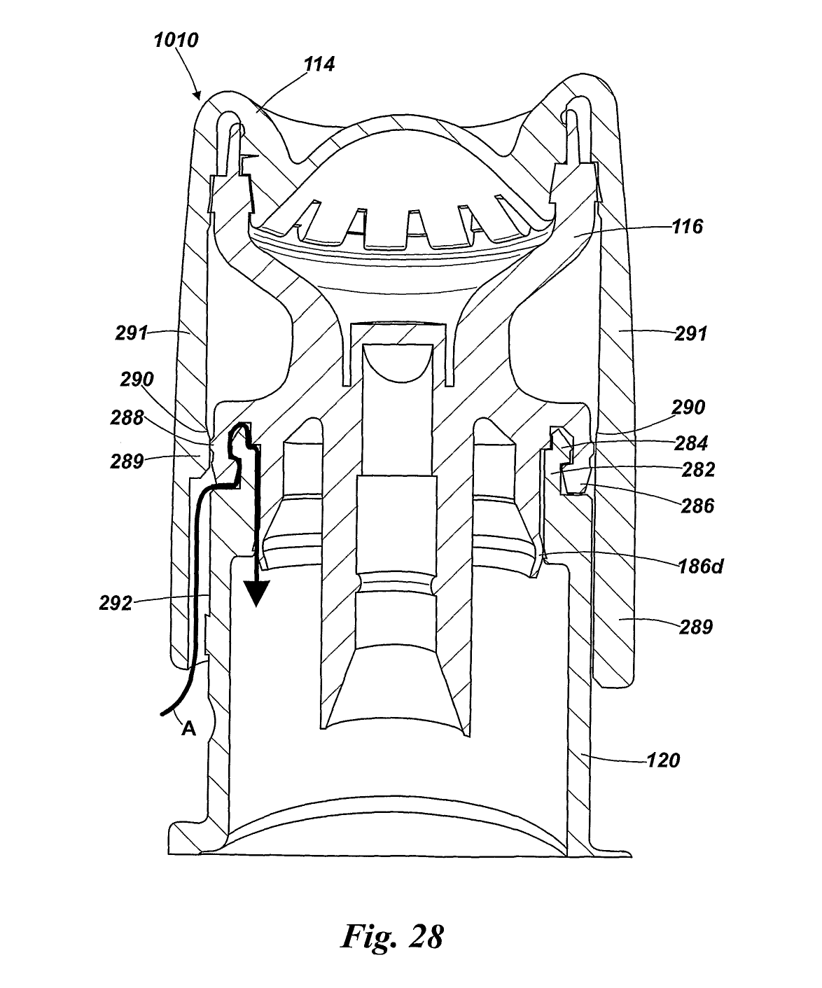

FIG. 28 is a longitudinal cross sectional view through part of the dispenser of FIG. 27;

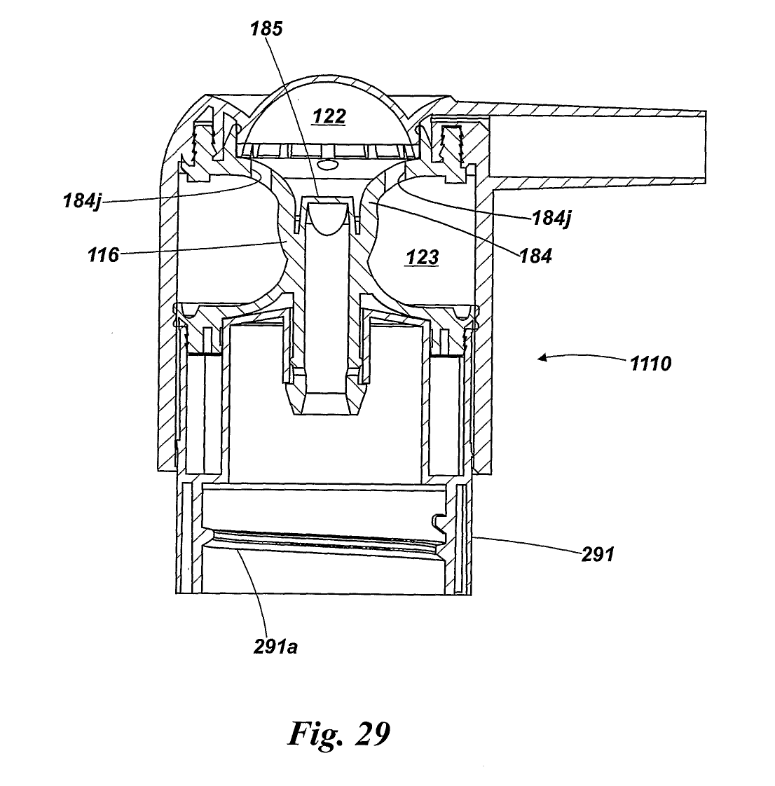

FIG. 29 is view similar to that of FIG. 4 of a yet further alternative embodiment of a dispenser in accordance with the invention;

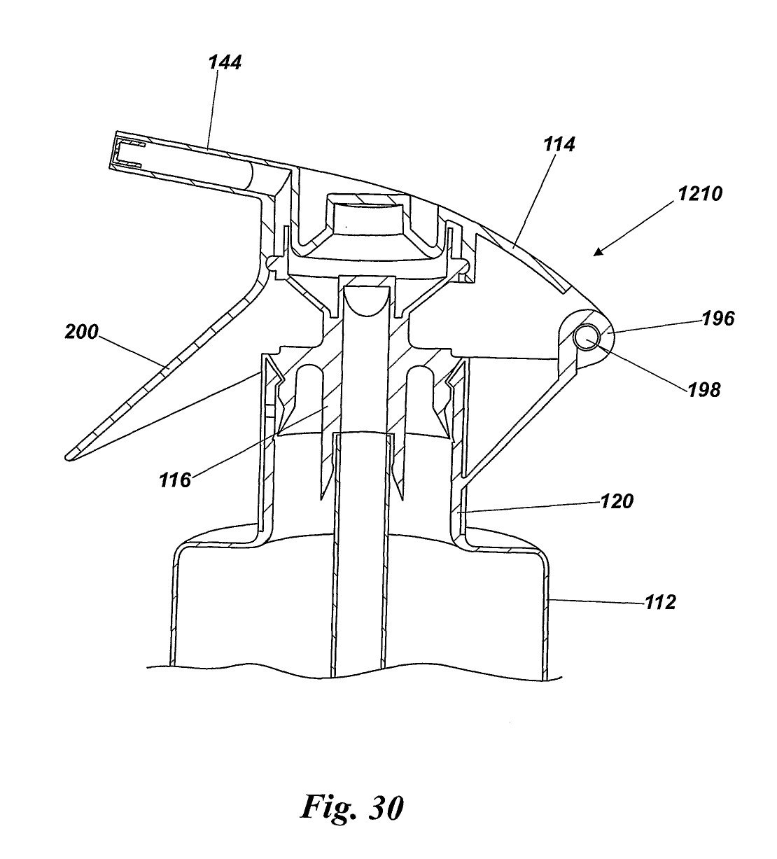

FIG. 30 is a view similar to that of FIG. 4 showing a further embodiment of a dispenser in accordance with the invention including a trigger actuator;

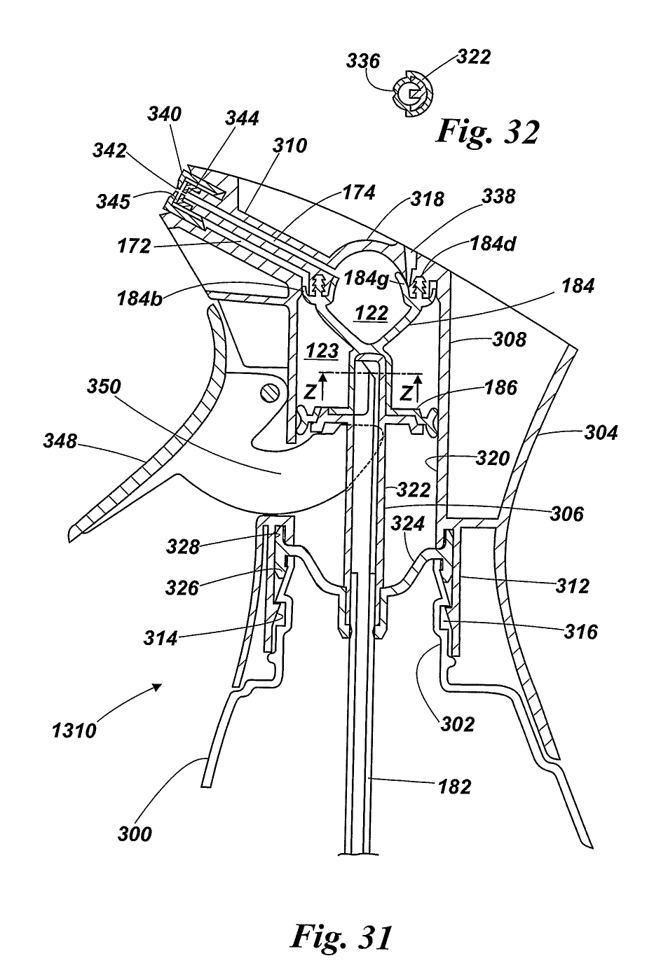

FIG. 31 is a cross sectional view similar to that of FIG. 4 showing a further embodiment of a dispenser in accordance with the invention including a trigger actuator;

FIG. 32 is a cross sectional view through part of the dispenser of FIG. 31 taken on line Z-Z;

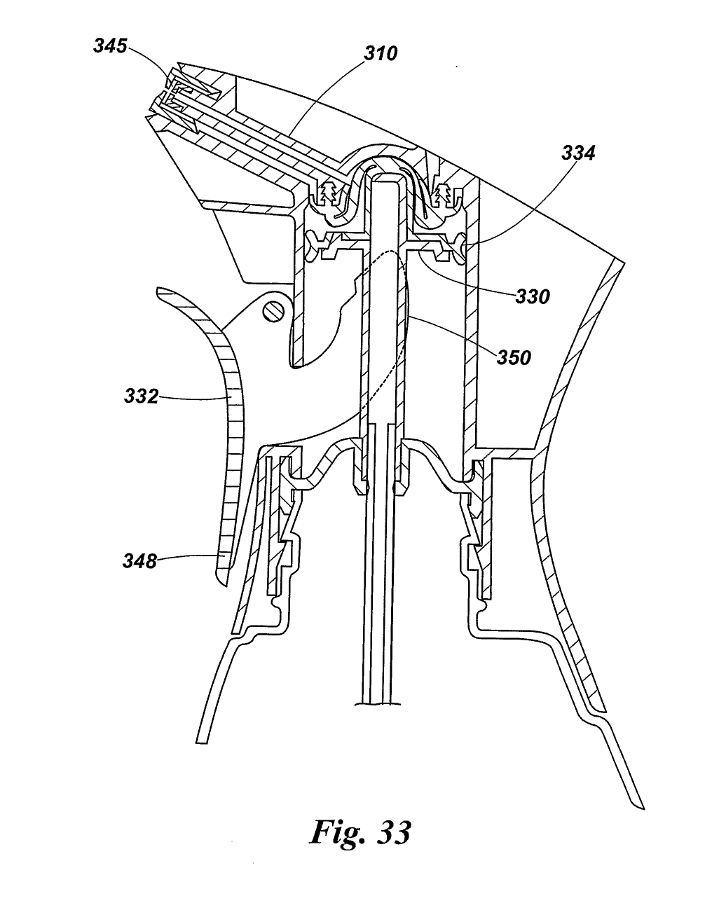

FIG. 33 is a view similar to that of FIG. 31 but showing the dispenser in mid-actuation with the insert full deformed; and

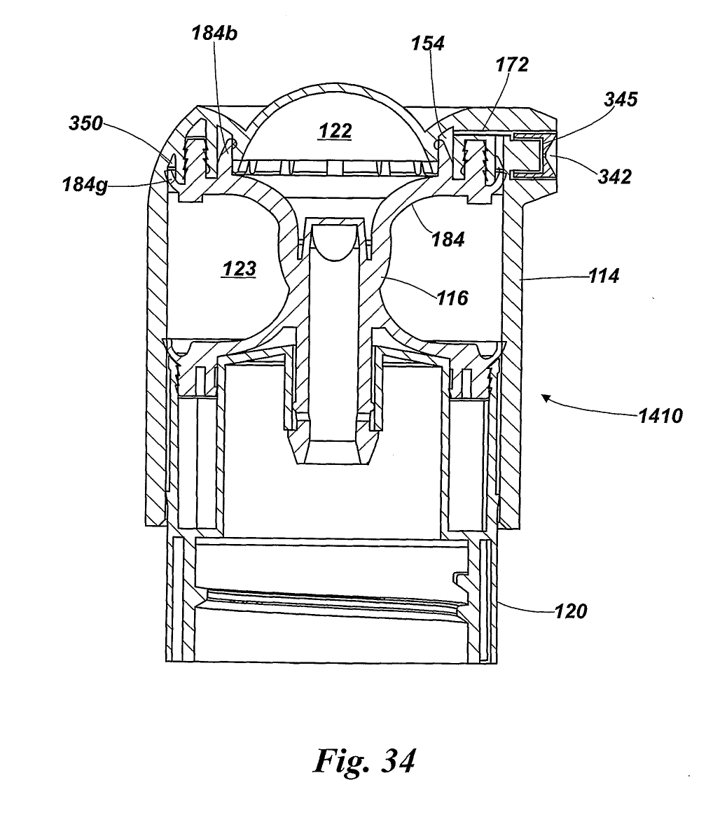

FIG. 34 is a cross sectional view similar to that of FIG. 4 showing a further embodiment of a dispenser in accordance with the invention.

Dispensers in accordance with the invention can be manufactured using any suitable apparatus and methods but can be at least partly manufactured in a convenient and economical manner using the various moulding apparatus and methods described in the applicant's co pending patent applications Nos. PCT/GB2006/002751 (published as WO2007/010286) and PCT/GB2008/002558, the contents of which are hereby incorporated by reference. The reader should refer to these and related patent applications for a full description of the apparatus and methods.

FIGS. 1 to 7 show a first embodiment of a manually actuated pump dispenser 110 in accordance with the invention. The dispenser 110 comprises three component parts, a container 112, an actuating cap 114 and an insert 116 (otherwise referred to as a pump member or pump member insert), at least parts of which are resiliently flexible.

The container has a main body 118 for receiving a fluid to be dispensed and an open neck region 120 which forms a first or base part of the dispenser pump. The cap 114 is mounted to the neck region 120 and forms a second or upper part of the dispenser pump. The insert 116 is mounted between the cap 114 and the neck region 120 to define a main or first pump chamber 122 and, in this embodiment, a second pump chamber 123.

The container 112 and cap 114 are preferably formed from a polymeric material such as polyethylene, polythene or the like using injection and/or blow moulding techniques as will be discussed in more detail later. The insert 116 may also be formed by injection moulding from a polymeric material. Typically, the insert 116 is made from a material which once moulded remains resiliently flexible such as TPV, TPE, PP, silicon or the like. However, the flexible insert could also be manufactured using bi-injection techniques so as to have a core or framework of a more rigid material onto which the flexible portions are over moulded. This would provide for additional strength. The cap 114 and at least the neck 120 of the container are typically formed from a material which is substantially rigid once moulded, or at least substantially rigid when compared with the flexible portions of the insert 116. The main body 118 of the container may also be substantially rigid after moulding or it may be flexible.

The neck region 120 of the container 112 is substantially annular in shape and has a ridge 124 extending around its outer surface and which separates an upper portion 120a of the neck from a lower portion 120b. The upper portion 120a has a slightly smaller outer diameter than the lower portion 120b. Two diametrically opposed grooves 126, only one of which can be seen, extend longitudinally through the ridge 124 and into the lower portion 120b. Two pairs of stops 128, 130 project radially outwardly from the outer surface of the upper region 120a adjacent the ridge 124. A first pair of stops 128 are positioned adjacent each of the grooves 126, whilst the other pair of stops 130 are aligned at approximately 90 degrees to the first pair in a circumferential direction.

The upper edge of the neck 120 has flange 132 which angles inwardly to support the flexible insert 116 as will be described in more detail below. A small opening 134 extends through the wall of the neck to provide an air inlet to the container as will also be described in more detail below.

The cap 114 has an annular main body portion 136 which is received over the neck region 120 of the container. An inwardly directed flange 138 is formed at the lower edge of the main body for cooperation with the ridge 124 on the neck of the container to prevent the cap 114 from being accidentally removed from the neck 120 after fitting. The arrangement is such that the cap 114 can be pushed onto the neck 120 so that the flange 138 passes over the ridge 124 to engage with the lower surface of the ridge. In normal use, upward movement of the cap 114 relative to the neck 120 is limited by contact between the flange 138 and the ridge 124 to an upper rest position as shown in FIG. 1.

A pair of diametrically opposed, longitudinal locking tabs 140 project radially inwardly from the inner surface of the main body portion 136 of the cap. A lower edge 142 of the tabs 140 is arranged to be positioned just above the upper surface of the annular ridge 124 on the neck 120 when the cap 114 is in its upper rest position as shown in FIG. 1. In this position, the cap 114 can be twisted between a locked position in which the tabs 140 abut the second pair of stops 130 on the neck and an unlocked position in which the tabs 140 abut the first pair of stops 128. When the cap 114 is in the locked position, it is prevented from being depressed as the tabs 140 contact the upper surface of the ridge 124 on the neck. However, when the cap 114 is in the unlocked position the tabs 140 are aligned with the grooves 126 and the cap 114 can be depressed to the position shown in FIG. 2, with the tabs 140 entering and sliding along the grooves 126. This provides a simple twist locking mechanism that enables a user to lock the dispenser 10 against accidental actuation. Any other suitable means of locking the cap against accidental actuation can be used.

An outlet 144 is formed at an upper region of the cap 114. In the embodiment as shown in FIGS. 1 to 3, the outlet is in the form of an elongate spout having an oval cross section shape with a large internal outlet passage 146 suitable for dispensing a paste, gel or foam. In contrast, the outlet 144′ shown in FIGS. 4 to 7 incorporates an “atomizing” nozzle suitable for dispensing a liquid as an atomised spray or fine mist. It will be appreciated by those skilled in the art that the outlet 144 can be modified in numerous ways depending on the application and the type fluid to be dispensed. For example, in the present embodiments the outlet 144, 114′ is directed generally perpendicular to the longitudinal axis of the container 112 so as to extend horizontally when the dispenser is in an upright position. However, the outlet 144, 114′ could be arranged to extend parallel to the longitudinal axis of the container so as to project upwards when the dispenser is positioned upright or indeed at any desired angle.

Where the outlet 144′ is in the form of a spray nozzle, a swirl chamber or other arrangement may be provided just prior to the final outlet orifice to encourage the fluid to spin about the axis of the orifice in a manner known in the art.

As can be seen best in FIGS. 4 to 7, the upper surface of the cap 114 includes an inwardly projecting collar 148. The collar 148 has first radially inner annular wall 150 which is connected at an outer or upper end to a second, radially outer annular wall 152 so as to provide an annular channel 154 between the two annular walls. The inner or lower end of the second annular wall is connected with the main body portion 136 whilst the inner or lower end of the inner annular wall 150 is connected to a central button 156 by means of a frusto-conical portion 158. A groove 160 is formed around the inner surface of the cap 114 at the junction between the outer annular wall 152 and the main body 136.

As mentioned previously, the outlet 144′ as shown in FIGS. 4 to 7 comprises a nozzle configured to generate an atomised spray of liquid. The outlet 144′ includes a short annular spout 162, a generally circular projection 164 located centrally within the spout and an end cap or spray insert 166 which locates within the spout about the projection. The insert 166 is a tight fit in the spout 162 but its inner surface is spaced from the outer surface of the projection to form outlet flow passages for the fluid. An end wall 168 of the insert has at least one small orifice or nozzle 170 through which the fluid is expelled as a spray. In an alternative arrangement which is not shown, the circular projection 164 may be omitted and the outlet nozzle formed by means of an insert mounted to the spout or other opening in the cap.

In the present embodiment, the dispenser 110 has two pump chambers, a first pump chamber 122 for pumping a liquid from the container and a secondary chamber 123 for delivering air to the outlet nozzle to mix with the liquid. A first opening 172 fluidly connects the interior of the outlet spout 162 with the annular space 154 between the first and second annular walls 150, 152 which forms part of an outlet flow path for the liquid from the first pump chamber 122. A second opening 174 fluidly connects the interior of the outlet spout 162 with the secondary pump chamber 123 to enable air from the secondary pump chamber to enter the outlet and mix with the liquid. The end face 164a of the projection and/or the inner surface of the end wall 168 of the insert may be shaped so as to form a swirl or vortex chamber in which the liquid and air are directed so as to rotate about the axis of the outlet orifice 170 in a manner known in the art. The air and the liquid may be kept separate in the outlet prior to entering the swirl chamber. This could be achieved for example by forming grooves and/or recesses on the inner surface of the insert 166 and/or the outer surface of the projection 164 to form separate flow paths for the liquid and air.

The spray insert 166 may be moulded in the same tool as the cap 114 and is connected with the cap by means of a flexible lanyard 166a as shown in FIG. 5. This arrangement assists in assembly of the dispenser as the cap 114 and insert 166 are held together to effectively form a single component part.

The insert 116 has a central core 176 and a central bore 178 which extends longitudinally through the core. An inner or lower end of the bore 178 has a region of increased diameter 178a which is adapted sit on an upper end region of a dip tube 180. The dip tube 180 extends towards the bottom of the container 112 to enable the contents of the container to be dispensed in a known manner. A small ridge 178b is provided on the surface of the enlarged diameter portion 178a. The ridge 178b contacts the outer surface of the dip tube 180 to form a point contact seal similar to that of an O-ring.

In the present embodiment, the dip tube 180 is formed integrally with the container. A lower end of the dip tube has an opening through which fluid can flow into a central bore 182. Although not shown in the drawings, the bottom of the container angles downwardly towards the centre of the container where the lower end of the dip tube is positioned. This arrangement ensures that substantially all the fluid in the container can be dispensed when the dispenser is positioned upright. Although it can be convenient to form the dip tube 180 as an integral part of the container, it will be appreciated that the dip tube could be a separate component in the known manner or it could be formed as an integral part of the insert.

The insert 116 is shaped like a double bell or hour-glass. A first upper bell-like portion or diaphragm member 184 contacts the interior surface of the cap 114 to define the first pump chamber 122. A second lower bell-like portion or diaphragm member 186 extends outwardly from the main core to contact and seal with the neck region 120 of the container. The lower diaphragm member 186 also seals with the interior of the main body 136 of the cap to define the secondary pump chamber 123 between the upper 184 and lower diaphragms 186 within the cap 114.

The upper diaphragm 184 includes a frusto-conical region 184a projecting upwardly and outwardly from the core 176 towards the inner surface of the main body portion 136 of the cap. A tubular region 184b extends from an upper end of the frusto-conical region 184a to contact the outer surface of the inner annular wall 150 of the collar 148. A semi-circular seal 184c is formed about the outer surface of the first diaphragm at the junction between the frusto-conical region 184a and the tubular region 184b. The seal 184c engages and seals in the groove 160. The tubular region 184b is resiliently biased into engagement with the outer surface of the inner annular wall 150 to form a seal separating the first pump chamber 122 from the outlet 144. The tubular region 184b acts as a flexible ring valve member to control the release of liquid from the first chamber 122.

The flexible insert also forms a one-way inlet valve 185 for controlling the flow of liquid into the first pump chamber 122 from the dip tube. The valve 185 can be of any suitable form and could comprise a flap valve or a duck valve for example.

The lower diaphragm 186 has a shoulder portion 186a which projects radially outwardly towards the neck 120 of the container 112 and a downwardly extending skirt 186b which extends into and seals with the inside of the neck region 120. A frusto-conical outer surface of the lower diaphragm 186 rests on the flange 132 of the neck region whilst an angled projection 186c on the skirt engages in an undercut below the flange 132. This secures the flexible insert 116 to the neck region 120 of the container. A further frusto-conical extension 186d of the skirt engages with the inner surface of neck 120 to form a point seal. The extension, contacts the neck at a point below air inlet 134 and acts as a valve to admit air into the container. If the pressure in the container falls below atmospheric as the contents are used up, the extension 186d is deflected away from the surface of the neck to allow atmospheric air to enter the container. At all other times, the extension 186d contacts the neck to form a seal preventing liquid from escaping through the air inlet 134 and the neck itself.

The lower diaphragm has a further frusto-conical extension 186e which extends upwardly to contact and seal with the inner surface of the main body portion 136 of the cap 114 to define the secondary pump chamber 123 between the upper and lower diaphragms 184, 186 and the cap 114. The further frusto-conical extension 186e is flexible and acts as a one way ring valve to admit atmospheric air into the secondary chamber after each actuation of the dispenser.

Operation of the dispenser 110 will now be described with reference in particular to FIGS. 6 and 7. The dispenser as shown in FIGS. 6 and 7 has a modified flexible insert 116 in which the inlet valve 185 for the first pump chamber is in the form of a duck-bill or fart type valve 185. This type of inlet valve 185 comprises a tube with a closed end having a slit 185a. When the pressure in the first pump chamber 122 falls as the flexible insert 116 recovers following each actuation, the slit 185a is opened to allow liquid to be drawn into the chamber. In a further modification, the flexible insert 116 is held in the neck region 120 of the container by a series of fins 188 instead of having a projection 186a which engages in an undercut. Eliminating the undercut in the neck 120 of the container makes it easier to mould. Other then these differences, the dispenser 110 shown in FIGS. 6 and 7 is constructed and operates in the same manner as the dispenser shown in FIGS. 1 to 5.

Assuming that the first pump chamber 122 and the secondary pump chamber 123 are fully primed with liquid and air respectively, the user initiates actuation of the dispenser by turning the cap to the unlocked position and depressing it. As the cap 114 is depressed, the conical region 184a of the upper diaphragm 184 of the flexible insert is deflected the downwardly and the volumes of the first pump chamber 122 and the secondary pump chamber are reduced. This results in an increase in the pressure of the liquid in the first pump chamber 122 and the air in the secondary pump chamber 123. Since liquid is incompressible, there will only be small change in the volume of the first pump chamber 122 initially with the conical region 184a deflecting downwardly to reduce the volume of the secondary pump chamber 123.

The increasing pressure of the liquid in the first pump chamber 122 acts on the inlet valve 185 to ensure it remains closed and on the tubular region 184b of the upper diaphragm 184. Once the pressure in the first chamber 122 has reached a predetermined level, the tubular region 184b is biased away from the inner annular wall 150 of the collar 148 so that the liquid flows under pressure into the annular channel 154 between the inner and outer annular walls 150, 152 of the collar and through the opening 172 into the outlet 144. The tubular region 184b thus acts as a pre-compression outlet valve ensuring that the liquid only flows from the first pump chamber 122 to the outlet 144 when it has reached a desired operating pressure suitable for producing a desired spray quality. The pressure at which the outlet pre-compression valve 184b opens is determined by the nature of the material used to form the flexible insert 116 and the thickness of the tubular region 184b. By selecting a suitable material and thickness, a designer can determine an appropriate opening pressure for the valve for any particular application.

At the same time, the increasing pressure of the air in the secondary chamber 123 acts on the further frusto-conical extension 186e of the lower diaphragm pushing it firmly onto the wall of the main body portion 136 of cap 114 to form a tight seal. As shown in FIG. 6, the opening 174 connecting the secondary chamber 123 to the outlet 144 is normally closed by a portion of flexible insert 190 which acts as a pre-compression outlet valve member for the secondary pump chamber 123 in a manner similar to that of the tubular region 184b described above. Thus the portion of the flexible insert 190 closing the opening 174 is moved to admit air into the outlet 144 once the pressure of the air reaches a predetermined value. The outlet valves for the first and secondary chambers 122, 123 may be arranged to open at the same pre-determined pressure or at different pressures. For example, the air may be admitted into the outlet slightly earlier than the liquid.

Once the outlet valves for the pump chambers have opened, as shown in FIG. 7, the user continues to depress the cap 114 further reducing the volume of the chambers so that the liquid and air continue to flow through the outlet where they are mixed prior to exiting through the outlet orifice 170 as an atomised spray. Once the cap has been fully depressed or when the user stops pressing the cap 114, the pressure in the pump chambers 122, 123 falls and the outlet valves 184b, 190 close.

When the user removes the actuation force from the cap 114, the resilience of the insert 116 (the upper diaphragm 184 in particular) biases the cap 114 back towards the rest position. As the cap 114 is moved back towards its rest position, the volumes of the first and secondary chambers 122, 123 increase and the pressure in the chambers falls creating a partial vacuum. Once the pressure in the first pump chamber 122 has fallen to a predetermined value, the inlet valve 185 opens and a fresh charge of liquid is drawn into the chamber. A fresh charge of air is also admitted as the reduced pressure in the secondary pump chamber 123 allows atmospheric air to push the further frusto-conical extension 186e of the lower diaphragm away from the wall of the cap 114. By the time the cap 114 has fully recovered to its rest position, both the first and secondary pump chambers are fully charged ready for a further actuation. The user can then either depress the cap 114 again to dispense further liquid or twist the cap to the locked position for storage.

The insert 116, and in particular the upper diaphragm 184, can be strengthened by adding reinforcing ribs or struts to increase the spring force with which the cap 114 is biased back to the rest position. FIG. 7 illustrates the dispenser 110 as the cap 114 reaches its fully depressed position. The tubular region 184b of the insert is shown deflected away from the inner annular wall 150 of the collar 148 to open a flow path from the first pump chamber 122 to the outlet 144. The flexible insert portion 190 has also been deflected to open a flow path through the second opening 174 from the secondary pump chamber to the outlet 144. It should be noted that the dispenser is designed to minimise the dead space in the pump chambers 122, 123 when the cap 114 is fully depressed. Thus the upper diaphragm 184 conforms closely to the shape of the collar 148 and overlies the angled surfaces of the lower diaphragm 184.

Dispensers in accordance with the invention can be manufactured using any suitable methods and apparatus. However, the container 116 and cap 114 can be cost effectively manufactured using the vertically stacked injection/blow moulding apparatus and methods described in the applicant's above referenced co-pending applications Nos. PCT/GB2006/002751 (published as WO2007/010286) and PCT/GB2008/002558, with a preform for the container being injection moulded in an upper station 12 and blown in a lower station 14. The neck region 120 of the container may be moulded in the upper station 12 or in the lower station 14 during the blow moulding phase. In some instances, part of the neck will be moulded in the upper station whilst additional features are added in the lower station. The cap 114 can also be injection moulded in the lower station 114 with suitable impressions in a split mould. Where the outlet 144 includes a spray nozzle insert 166, this can also be moulded in the lower station together with the cap. The flexible insert 116 will usually be manufactured in a separate injection moulding machine and assembled to the dispenser. As illustrated in FIG. 3, the insert is first assembled to the cap 114 which is then pushed on to the neck region 120 of the container and fully depressed so that the flexible insert 116 engages in the neck 120. The dispenser can then be primed.

In order to reduce the tooling space required, the mould for the cap 114 will usually be positioned above a shoulder region of the blow moulding cavity for the container 112. This enables the number of units that can be produced in a single tool to be maximised. In many applications, the main body 118 of the container will be larger than that shown in the drawings and may have a non-circular (e.g. oval or elliptical) shape in horizontal cross section so that it is wider when viewed from the front or rear than from the sides. In this case there will be sufficient room for the whole of the mould for cap 114 to be positioned above the blow mould cavity for the container but even where the container is small or circular, the mould for the cap can be positioned minimise the overall footprint of the moulds for the container and cap.

In the present embodiment, the cap 114 is moulded with a flexible lanyard 192 connecting it to the container 112. This is advantageous as it minimises the assembly process and reduces the overall number of separate parts that must be produced and controlled. However, the lanyard could be omitted. The lanyard is flexible to allow the cap 114 to be fitted to the container 112 and to allow the cap 114 to fall vertically upside down adjacent the container to make it easy to assemble the insert. The cap 114 and lanyard 192 can be arranged so that the cap rests on a shoulder or side wall of the container when the insert 116 is assembled.

FIGS. 8 and 9 show a modified dispenser 210 in which the lanyard 192 is adapted to twist. This arrangement is beneficial as it enables the cap 114 to be moulded horizontally, as shown in FIG. 8, with the underside being made in one part of a split mould tool and the topside in the other part of the tool. In this configuration the outlet spout 144 extends vertically and can be formed using retractable pins. As shown in FIG. 9, when the container 112 and cap 114 are removed from the mould, the lanyard twists to enable the cap 114 to fall upside down adjacent the container. The lanyard 192 is formed with a series of openings 193 at different angles to allow the twisting to occur. The lanyard 192 in this and all embodiments can be manufactured with frangible links to the cap 114 and container 112 so that it can be easily removed after the cap 114 has been assembled to the container 112 or on first use of the dispenser.

Whilst it is advantageous for the cap to be moulded together with the container and connected by a lanyard, it will be appreciated that the cap could be moulded separately from the container. In many applications it will be desirable to produce the cap 114 in a different colour to the container 112.

The dispensers, 110, 210 as described above can be modified in a variety of ways. For, example, whereas in the embodiments described liquid is pumped via the first chamber 122 and air is pumped via the secondary chamber 123, this arrangement can be reversed and the liquid arranged to be pumped through the secondary chamber, with the first chamber 122 adapted to pump air. This may require the insert to be modified to provide and flow path from the dip tube to the secondary chamber 123 with an inlet valve. The design would also have to be modified to enable air to be admitted into the first chamber 122 during the recovery phase. Where there is no requirement to mix air with the liquid in the outlet nozzle 144, the secondary pump chamber 123 can be omitted. In this case the lower diaphragm 186 need not be provided with the further frusto-conical extension 186e and the second opening 174 into the outlet 144 can also be omitted. Alternatively liquid can be dispensed through both the first and secondary pump chambers. If the same liquid is dispensed through the two chambers, this would enable a given dispenser to deliver a greater volume of liquid on each actuation without increasing the stroke. This may require the insert to be modified to fluidly connect the dip tube to both the first and secondary changes via an inlet valve. Alternatively, the dispenser could be modified to enable different liquids to be dispensed through the two pump chambers by fluidly connecting each chamber to a different liquid supply. For example, the container 112 can be divided into two by means of an internal wall with a dip tube 180 extending into each part. In this configuration, the insert 116 would be modified so as to fluidly connect one dip tube to the first pump chamber 122 and the other to the secondary pump chamber 123 and to form an inlet valve for each dip tube. Where the dispenser has two chambers to dispense two liquids they can be mixed in the nozzle or they can be directed through separate outlets to be mixed in the air externally of the dispenser nozzle.

FIGS. 10 and 11 illustrate embodiments of a dispenser 310, 410 having only a single pump chamber 122. The flexible insert 116 in this embodiment is similar to that described above in relation to FIGS. 6 and 7 in that it is held in the neck region 120 of the container by a series of fins 188 and the inlet valve 185 to the pump is in the form of a duck or fart valve. Because this embodiment does not have a secondary pump chamber, the further frusto-conical extension 186e of the flexible insert 116 is omitted.

A further modified embodiment of the dispenser 510 is illustrated in FIG. 12. This embodiment is similar to that described above in relation to FIGS. 6 and 7 and comprises a duck or fart type inlet valve 185 to the first pump chamber 122. A further modification involves the method of attaching the upper diaphragm portion 184 to the cap 114. Rather than having a semi-circular seal 184c engaging in a groove 160 as in previous embodiments, the upper diaphragm portion 184 has region of increased thickness 184d at the junction between the frusto-conical region 184a and the tubular portion 184b which extends between and is held in recesses between the inner and outer annular walls 150, 152 of the cap. Openings 194 are provided through the inner wall 150 through which the liquid can flow into the annular channel 154 between the inner and outer walls. The tubular region 184b of the insert functions as an outlet valve and is resiliently biased into contact with the inner annular wall 150 to close the flow path through the openings. When the pump dispenser is actuated, the increasing pressure of the fluid in the first chamber acts on the inner surface of the tubular region 184b. When the pressure of the fluid reaches a pre-determined value, it deflects the tubular region 184b away from the inner annular wall to allow fluid to pass from the first pump chamber into the channel 154 and the outlet.

Dispensers in accordance with the invention can be adapted for use as dosing dispensers by varying the size the pump chamber or chambers to control the discharge or dose of liquid dispensed on each actuation. Dosing dispensers can have many applications including dispensing of pharmaceuticals. A dosing dispenser may include a second chamber for mixing air with the liquid or dispensing two liquids. The volume of the second chamber can also be fixed to provide a dual dispensing pump.

Whilst is its preferred that the inlet and outlet valves for the pump chamber or chambers comprise resiliently flexible valve members formed integrally as part of the insert 116, alternative valve arrangements can be used. For example any of the valves could be replaced by a valve insert, which may comprise a ball type valve for example.

The outlet 144 of the dispenser can be modified in a variety of ways depending on the type of fluid being dispensed. Where the fluid is to be dispensed as a foam, for example, a filter mesh can be incorporated into the outlet. FIG. 13 illustrates an embodiment of a dispenser 610 which is adapted to dispense a mixture of air and a liquid product as a foam.

The dispenser 610 in FIG. 13 is similar to the dispenser 110 described above with reference to FIGS. 1 to 7 and comprises an insert 116 which defines a first pump chamber 122 for dispensing a liquid product from a container and a secondary pump chamber 123 for dispensing air to be mixed with the liquid product in the outlet 144. In this embodiment, the outlet 144 comprises an elongate spout having a large diameter outlet passage 146 surrounding an atomizing or spray outlet 145 through which the liquid product is sprayed into the passage 146 from the first pump chamber 122. The air from the secondary chamber 122 is introduced directly into the outlet passage 146 from the secondary pump chamber though an air outlet passage 174 where it mixes with the liquid product to produce a foam. Means for refining the foam can be included in the outlet passage 146. This might include one or more mesh filter screens as is well known in the art. However, in the present embodiment, a plug 210 of open celled foam or another suitable three dimensional mesh structure is located in the outlet passage 146. For convenience, the plug 210 may be held in an insert 212 which locates in an outer end of the outlet passage 146 as shown or it may be located directly in the outlet passage.

The dispenser 610 as shown in FIG. 13 is otherwise constructed and operated in a similar way to the dispenser 110 in FIGS. 1 to 7 described above. The main differences being the way in which the upper diaphragm 184 is located within the cap 114 and the air release arrangements.

In the present embodiment, the upper diaphragm 114 of the flexible insert has a flange 184d which is received in the annular gap 154 between two spaced annular walls 150, 152 which project inwardly from the upper surface of the cap 114. The inner annular wall 150 and the flange 184d have inter-engaging formations 184e, 150a which lock the flange 184d in position. An outer lip seal 184f engages with inner surface of the side wall of the cap to define together with the lower diaphragm 186 and the side wall of the cap 114 the secondary air chamber 123. Part 184g of the lip seal 184f adjacent the air outlet passage 174 acts as an outlet valve for the secondary chamber and can be deflected inwardly away from the wall to allow air to enter the air outlet passage 174 when the dispenser is actuated. The lower diaphragm has a seal 186e which engages the wall of the cap to seal the lower end of the secondary chamber. As with the embodiment shown in FIGS. 1 to 7 and described above, the seal 186e acts as a one way valve to admit atmospheric air into the secondary chamber 123 when the cap 114 recovers to the rest position after each actuation.

A second lip seal 184h on the upper diaphragm 184 engages with an upper surface of the cap 114 to define the first liquid pump chamber 122 between the upper diaphragm 184 and the upper surface of the cap. At least part 184i of the second lip seal 184h adjacent the liquid outlet passage 172 acts as a pre-compression valve to control the release of liquid from the first pump chamber 122 when the pump is actuated. When the cap 114 is depressed, the pressure of the liquid in the first pump chamber 122 is increased. The increasing pressure of the liquid in the first pump chamber acts on the second lip seal 184h causing at least the portion 184i to deflect away from the cap to allow the liquid to enter the passage 172 when the pressure of the liquid reaches a predetermined desired value. In this embodiment, the inlet valve for the first pump chamber 185 is in the form of a duck bill or fart type valve.

Although the liquid in the first pump chamber is incompressible, in practice there will usually be a small quantity of air in the chamber as a result of the dead space left when the insert 116 is fully deformed. The presence of some air in the first chamber enables the insert to deform slightly compressing the second chamber 123 and pressurising the air inside by a limited amount. However, the pressure of the air in the secondary chamber 123 will not be raised significantly before the outlet valve for the liquid chamber 122 opens. Consequently, air from the air chamber 123 will be delivered to the outlet passage at a pressure which is only slightly above atmospheric and the outlet valve 184g for the air chamber can be configured to open at the same time as or just before or just after the outlet valve 184i.

Typically the dispenser 610 will deliver the air and liquid at a ratio in the range of 6:1 to 10:1 by volume. If necessary, the volume of the air chamber 123 can be increased by making the diameter of the cap larger than is shown and the cap may have a diameter which is significantly larger than that of the neck region 120.

In some circumstances, it may be desirable to raise the pressure of the air in the air chamber 123 above atmospheric. In this case, the dispenser can be modified to enable the volume of the air chamber 123 to be reduced before the liquid chamber outlet valve 184i opens. This can be achieved in a number of ways. For example a balloon or other compressible body containing a gas may be located within the liquid chamber. When the dispenser is actuated, the balloon or body will compress initially to allow the cap to move relative to the neck 120 so that the volume of the air chamber is reduced and the air pressure increased before the pressure of the liquid in the first chamber 122 is raised.

In the present embodiment, there is no opening 134 through the neck 120 to admit air into the container. Rather a small air passage (not shown) is provided between the flexible insert 116 and the inner surface of the neck through which air can be admitted into the container. The passage may be open all the time or the insert may be configured so that a passage is formed when the pressure in the container is below atmospheric. This arrangement can be adopted in any of the embodiments described in the application instead of the air hole 134.

In the present embodiment, a central region 156 of the upper surface of the cap 114 is indented and shaped like a dome. This is to reduce the amount of dead space in the first chamber 122 as the upper diaphragm 184 of the insert enters and conforms closely to the shape of the domed region when the cap 114 is fully depressed.

The use of a plug 210 of open celled foam in the outlet passage 146 is a convenient way of refining the foam but is not always as effective as a series of separate screens, in which foam is re-formed after passing through one screen and is then passed through another screen to be further refined. This is particularly true where the fluid is of a higher viscosity. FIGS. 14a to 15b illustrate modified plugs 210′, 210″ which each have two enlarged cavities or gaps 214 spaced along its length. The gaps 214 are positioned so that they extend across at least a central third region of the cross sectional area of the plugs through which a majority of the liquid/foam passing through the plug will flow. The gaps 214 divide the pug in to separate portions along its length and act like the spaces between screens so that foam is formed in each of the gaps which is then further refined as it is pushed through the following section of the plug. In the plug 210′ as shown in FIGS. 14a and 14b, the two gaps extend from opposite sides of the plug across the central region. In the plug 214″ shown in FIGS. 15a and 15b, gaps are formed so as to extend only across a central region through which the majority of the foam will pass. The number and shape of the gaps 214 can be varied to suite the application. The modified plugs 210′, 210″ are inexpensive to manufacture and can be easily inserted into the outlet passage but have been found to highly effective.

The modified plugs 210′, 210″ are not limited to use with dispensers in accordance with the invention but could be adopted for use with any suitable foam dispensers. Accordingly, patent protection may be sort for this concept independently of any other inventive concept and/or any of the embodiments disclosed in this application.

In known foam dispensers, liquid is introduced into a foaming chamber though simple holes which produce jets. This has been found to produce only low quality foam. In present embodiment, the dispenser 610 is configured so that the liquid is sprayed into the passage 146 through a nozzle 145 onto the foam plug 210. Air is introduced separately into the passage 146 where it mixes with the liquid to produce a foam. The region of the passage 146 between the nozzle 145 and the plug 210 can be considered an expansion or foaming chamber. Because the air is mixed with the liquid downstream of the nozzle 145 where the pressure of the liquid is reduced, the air does not have to be raised to the same pressure in the secondary chamber as the liquid in the first pump chamber. This helps to keep the activation force required to operate the dispenser low. In one embodiment, the spray nozzle 145 is configured to produce a cone spray and is be preceded by a swirl or vortex chamber. However, in some applications where the liquid is viscous and/or where there is insufficient distance between the nozzle and the screen or plug filter, a conical spray may not be formed and the liquid will jet through the nozzle adversely affecting the quality of the foam produced and may, in certain circumstances, prevent any foaming from taking place. In order to address this problem, it has been found that good quality foam can be produced by using one or more fan jets to produce a fan shaped spray rather than a cone shaped spray. This has been found to effect with viscous fluids or in other circumstances where a cone shaped spray could not be formed. The fan jet nozzle may be in the form of an elongate or eye-shaped orifice.

In a further alternative arrangement, a flood jet nozzle is used to create a sheet of liquid in the expansion chamber or passage 146 rather than a spray. This has also been found to be effect in producing high quality sprays, in particular with viscous liquids. FIGS. 16a and 16b illustrate one embodiment of a flood jet nozzle which is being used in combination with a modified plug 210′ of expanded foam. In this embodiment, the liquid is introduced into the foaming chamber 216 in the outlet passage 146 through a lateral opening 218 in the passageway and is directed on to a curved ramp 220 which turns the direction of movement of liquid through an angle so that it is directed on to the plug 210′. The ramp 220 may turn the liquid through an angle of approximately 90° but the angle could be anywhere between 60° and 120°. This creates a fan shaped sheet of liquid, which in the present embodiment is aligned substantially vertically when the dispenser is upright. The ramp 220 may have side walls to prevent the fan spreading and could be formed as a groove in the end wall region 222. The width of the ramp is selected as appropriate for any particular application. The lateral opening 218 and the ramp 220 are positioned substantially centrally along a diameter of the circular end wall 222. Air is introduced into the chamber 216 through a series of orifices 224 in an axial direction through the end wall 222 of the passage to mix with the liquid but the air can be introduced in any direction and in any suitable position. The surface of the ramp 220 may be smooth or it may be shaped or textured, as illustrated at 226 in FIG. 17, to break up the fan of liquid. In a further alternative the ramp 220 could be constructed so that it moves when the liquid impacts on it to break up the fan. The dispenser outlet could be provided with more than one liquid inlet 218 and ramp 220. A further alternative embodiment is illustrated in FIG. 18 in which the liquid is introduced into the chamber 216 though an inlet passage 228 which is aligned axially with the passage 146 and the ramp 220 is arranged to direct the fan on to a side wall of the passage 146 so that it is deflected off the wall onto the plug 210′.

The above embodiments all produce a fan shaped sheet of liquid. FIGS. 19a and 19b illustrate an embodiment in which the flood jet nozzle 145′ is arranged to produce a conical sheet of liquid. In this embodiment, the liquid flow passage 172 from the pump chamber has conically divergent outlet region 248 through which the liquid flows into the outlet passage 146 of the dispenser. A flow divider 250 is suspended centrally within the conically divergent outlet region 248 by means of three links 252. The flow divider has a conical region 254 which locates within the divergent outlet region 248 so that the outer surface of the conical region 254 is spaced from the surface of the passage to define an annular frusto-conical passage 256 about the divider through which the liquid flows to enter the outlet passage 146. The outer end of the flow divider is hemispherical in this embodiment but can be any suitable shape. The liquid flowing through the annular frusto-conical passage 256 about the divider passes through the gaps between the links 252 to form a generally conical sheet of liquid in the outlet passage 146 which is directed on to a plug 210, 210′, 201″, which can be of any of the types described above. The plug 210 can be replaced by any other suitable screen or filter for refining the foam. Air is introduced separately into the passage 146 to mix with the liquid by any suitable means including any of those described above in relation to FIGS. 16 to 18. This arrangement differs from a cone spray nozzle as the liquid is not formed into a spray as it passes through the jet nozzle put forms a conical sheet of liquid. This has been found to be particularly effective at producing good quality foams with viscous liquids which are unsuitable for producing a conical spray in the outlet of a foam dispenser of the types used to dispense consumer products.

Flood jet nozzles which produce a sheet of liquid rather than a spray or a simple circular jet can be advantageously used in any suitable type of foam dispenser and their use is not limited to the embodiments disclosed in the present application. Accordingly, patent protection for this concept may be sought independently of any other inventive concepts disclosed and/or claimed in this application.

A particular problem with foam dispenser is the tendency for material left in the outlet passage to continue to foam for a period after each actuation. This can lead to a bead of foam forming at the outlet or with the residue being expelled when the dispenser is next used, neither of which is desirable. It has been found that this problem can be overcome or reduced by drawing some or all of the residue back into the liquid pump chamber together with some air from the outlet passage. To achieve this, the outlet valve from the liquid dispenser is configured so that it does not fully seal the outlet of the liquid chamber, at least during an initial part of the recovery phase, so that the residue is drawn back into the chamber as it recovers. The amount of residue and air drawn into the chamber in this way is small in comparison with the total liquid which drawn into the liquid chamber through the inlet. This arrangement can advantageously be used in any suitable type of foam dispenser and its use is not limited to the embodiments disclosed in the present application. Accordingly, patent protection for this concept may be sought independently of any other inventive concepts disclosed and/or claimed in this application.

For various reasons, many liquid products are now being supplied in a concentrated form that has low water content. This can be desirable as the overall volume of liquid supplied is reduced which enables smaller containers to be used reducing packaging, storage and transport costs and waste. A problem with this approach is that the concentrated liquids are difficult to foam. Adding water to the liquids prior to dispensing improves the quality of the foam that can be produced but is impractical with conventional dispensers. FIG. 20 illustrates a further embodiment of a dispenser 710 which is adapted to provide a solution to this problem.

The dispenser 710 as shown in FIG. 20 is essentially the same as the dispenser 610 in FIG. 13 and comprises an actuator cap 114, a flexible insert 116 and a base 112. In this embodiment, the base is in the form of an adaptor having a screw thread for attachment to the neck of a container. The insert 116 defines a first liquid pump chamber 122 between itself and a wall 258 of the cap and an inlet valve 185 through which a concentrated liquid product can be introduced into the chamber from the container. A dip tube will normally be mounted to the insert as with previous embodiments but is omitted from FIG. 20. An outlet passage 172 connects the liquid chamber 122 with a nozzle 145 and the main outlet passage 146 of the dispenser in which a modified plug 210′ is located. A lip seal 184h on the upper diaphragm 184 of the insert controls the flow of liquid from the chamber 122 to the outlet passage in a manner similar to that described above in relation to the previous embodiments. An air chamber 123 is defined between a side wall of the cap 114 and the upper and lower diaphragms 184, 186 and is connected with the outlet passage 146 by means of a further passage 174 and an outlet valve 184g. As so far described, the dispenser 710 in FIG. 20 is essentially the same as and operates in a similar manner to the foam dispenser 610 shown in FIG. 13. However, the dispenser 710 in FIG. 20 differs from the earlier embodiments in that it is provided with a refillable fluid reservoir 260 which is defined in an upper region of the cap above the wall 258. A removable closure 262 is mounted to the cap 114 to close the reservoir. The closure is a clip fit on the cap and can be removed to enable the reservoir to be filled with water.

A fluid passage 264 is formed through the wall 258 to fluidly connect the reservoir 260 with the liquid pump chamber. A resiliently flexible one way valve member 266 is mounted to the wall 258 and is configured to allow water to be drawn from the reservoir into the liquid chamber through the passage 264 when the pressure in the chamber falls below atmospheric during the recovery phase. The valve 266 closes the passage 264 to prevent liquid flowing from the chamber 122 into the reservoir 260 when the liquid in the chamber is pressurised during the delivery phase of actuation. This allows an amount of water to be drawn into the liquid chamber 122 to mix with and dilute the liquid product drawn from the container as the chamber 122 recovers after each actuation. The ratio of liquid product to water drawn into the chamber 122 is determined by the relative cross section areas of inlets 185, 264 into to the chamber 122 from the container and the reservoir and will be selected as appropriate to the application. Typically in a foam dispenser a ratio in the region of 3:1 of product to water is expected but the ratio could be anything up to 1:1 or in some cases more water may be introduced than liquid product. The reservoir 260 will normally be relatively small and will require re-filling by the user before the container is emptied. This is simply done by removing the closure 262 and filling the reservoir from a tap. This helps to keep the overall size of the dispenser small enabling all the benefits of smaller packaging to be maintained. Alternatively, where re-fill containers of product are supplied for use with a dispenser pump, the reservoir could be dimensioned so that a single filling is sufficient to last for the life of each re-fill. If a further alternative arrangement, the reservoir could be dimensioned to last for the life of the container and can be filled and permanently sealed prior to supply to a user.

In some applications it will be preferable that the water is not introduced into the same pump chamber as the liquid product. In this case an additional pump chamber can be used to pump the water, which is mixed with the liquid product in the outlet. The water and product may be mixed prior to the nozzle 145 or in an expansion chamber downstream of the nozzle. Where there is no requirement for air to be mixed with the liquid, the dispenser can be modified so that one of the first and secondary chambers 122, 123 pumps the water, whilst the other pumps the liquid product.

Whilst the provision of a water reservoir for diluting a concentrated liquid product is particularly beneficial in foam dispensers, it could also have application in other types of manual pump dispensers, including spray dispensers, and in aerosol type dispensers. It should also be noted that the provision of a water reservoir for diluting a concentrated liquid can advantageously be applied in any suitable type of dispenser and its use is not limited to the embodiments disclosed in the present application. Accordingly, patent protection for this concept may be sought independently of any other inventive concepts disclosed and/or claimed in this application.

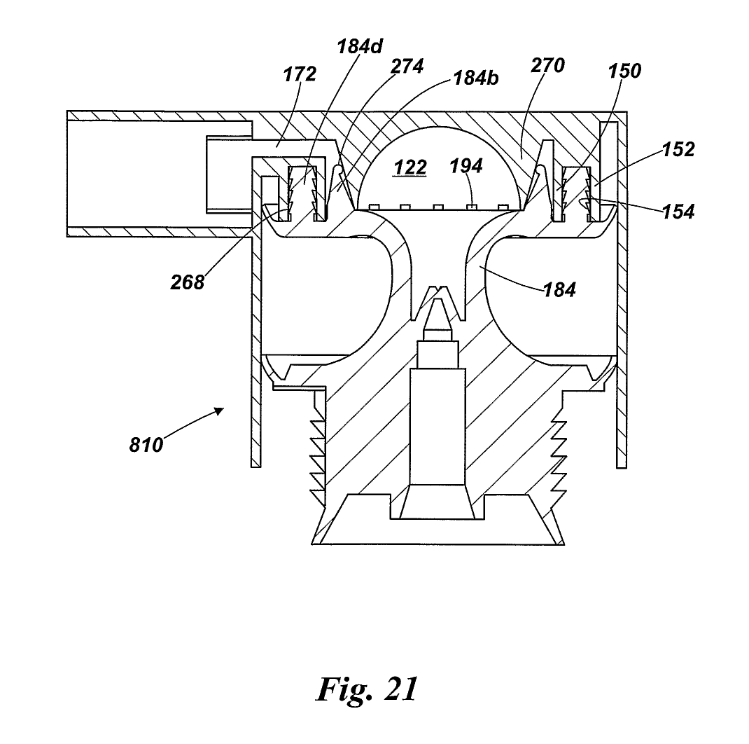

FIG. 21 illustrates a yet further embodiment of a dispenser 810 in accordance with the invention. The dispenser shown in this embodiment can be adapted for use as a foam, spray or any other type of dispenser.

The dispenser 810 shown in FIG. 21 is very similar to the dispenser 610 shown in FIG. 13 and only certain key differences or features will be described. The container is omitted from FIG. 21 which shows only the actuator cap 114 and the insert 116.

An important aspect of the design of dispensers in accordance with the invention is the requirement to hold the upper diaphragm 184 in position within the actuator cap 114. In this embodiment, the upper diaphragm 114 has an upwardly (as shown) directed flange 184d which is received in an annular groove 154 defined between two spaced annular walls 150, 152. The flange 184d is provided with a number of downwardly directed ridges 268 which engage with the walls 150, 152. The flange 184d and the ridges 268 are resiliently flexible and are configured to enable the flange to be easily inserted into the recess 154 but to resist the flange 184d being pulled out of the recess. This provides a simple method of locating the upper diaphragm 184 in the cap which is easy to manufacture and assemble.

Another important aspect of the dispenser is the outlet valve arrangement for the liquid pump chamber 122. In many pump action dispensers it is desirable that the liquid to be dispensed is only released from the pump chamber when it has a reached a pre-determined pressure above atmospheric. This particularly important in spray dispensers where the liquid needs to be forced through the nozzle at a sufficiently high pressure that a good quality spray is produced. If the outlet valve from the liquid pump chamber opens too early at the beginning of the delivery stoke when the pressure of the liquid in the pump chamber is below an optimum operating pressure, the liquid may initially splutter as it passes through the nozzle rather than forming a spray. It is also important that the outlet valve close quickly and cleanly as the pressure of the liquid drops of towards the end of the delivery stroke. In the previous embodiments, the outlet valve for the liquid pump chamber has been provided by means of a resiliently flexible annular or tubular seal portion 184b of the insert which abuts a wall of the cap to close off the flow passage from the chamber 122 to the outlet. The seal portion is resiliently biased into contact with the wall and the pressure of the fluid in the pump chamber acts on the seal portion to deflect it way from the wall and the seal portion is configured so that it moves to open the outlet when the pressure in the chamber reaches a pre-determine value above atmospheric for the application. In the previous embodiments, the seal portion 184b has been arranged to make surface to surface contact with the wall. Whilst the arrangement works well, it has been found that a more reliable operation of the vale is achieved if the seal portion 184b makes contact with the wall along a line which is close to the free end of the seal portion.

In the embodiment shown in FIG. 21, the main, and in this case the liquid chamber, 122 is defined between the upper diaphragm 184 and a conical projection 270 on the inner surface of the upper part of the cap 114. The projection 270 is located inside and spaced from the inner annular wall 150 so that an annular outlet channel 272 is formed about the projection which is in fluid connection with the outlet of the dispenser by means of a fluid passage 172. Openings 194 are provided though an edge of the projection through which liquid can flow from the chamber 122 into the annular outlet channel 272 and hence into the outlet passage 172. The flow of liquid through the openings 194 is controlled by a resiliently flexible annular seal member 184b of the insert which locates in the channel 272 so that in its initial resiliently biased configuration a free end of the seal member contacts the outer surface of the projection at a position above the openings 194. With the seal member in contact with the projection, the flow path through the openings 194 into the channel is closed. When the dispenser is actuated to compress the chamber 122, the liquid pressure in the chamber acts on the inner surface of the seal member 184b tending to deform the seal member outwardly against its inherent resilience. The seal member 184b is configured so that it is only deflected far enough to open a flow path when the pressure of the liquid in the chamber 122 reaches a pre-determined value.

As discussed above, it can be advantageous if the seal member only contacts the surface on which it seals at or close to its free end. In the present embodiment, this is facilitated by the angled outer surface of the conical projection 270. However, this could also be achieved by angling the seal member 184b only or by angling both the surface and the seal member. The effectiveness of the seal is further enhanced by providing a resiliently compressible enlargement or ring 274 at the free end of the seal member. The ring 274 acts like an o-ring seal making line contact with the outer surface of the projection. This facilitates quick and clean opening and closing of the valve. In addition, the compressibility of the ring 274 enables the seal member to deflect outwardly over a limited range before the seal is broken. This enables the seal member 184b to be configured to open at a set pressure more reliably than with a surface to surface contact. This principle will be described with reference to FIGS. 22a-22c which show a similarly constructed seal member 184b which is used to control the flow of a liquid though an outlet 276 from a pimp chamber 122 into an outlet passage 172.

FIG. 22a shows the seal member 184b in its initial resiliently biased condition when the fluid pressure in the chamber 122 as at atmospheric. In this condition, the ring 274 is biased into contact with a wall 278 of the cap and the flow path through the outlet 276 to the passageway 172 is closed. The ring 274 in this state is compressed. In FIG. 22b, the liquid in the chamber is pressurised but is below the optimum operating pressure at which the seal member 184b is configured to open. The fluid pressure acting on the seal member 184b has deflected part of the seal member away from the wall but the ring 274 is partially expanded from its initially compressed condition so that it remains in contact with the wall to close the flow path. FIG. 22c shows the seal in an open position after the liquid in the chamber 122 has reached the pre-determined operating pressure. The seal member is deflected sufficiently that the ring is lifted of the wall 278 to open a flow path through the outlet 276 into the passage 172. Because the ring 274 enables the seal member 184b to move by a limited amount before the valve opens, it facilitates configuration of the valve to reliably open and close at the pre-determined pressure.

It is preferred that the enlargement 272 has a curved profile which contacts the wall 278 so that it acts like an o-ring to provide a point or line contact between the seal and the wall but this is not essential.

This seal arrangement can be adopted in many different types of dispenser and is not limited to use in the embodiments disclosed in the present application.

Accordingly, patent protection for these seal arrangements may be sought independently of any other inventive concepts disclosed and/or claimed in this application.

Many pump dispenser outlets include a spout 144 which projects from the main body of the actuator cap 114 or body. In dispensers that require various features to be incorporated in the outlet, the spout may be longer than is ideally desired. This is particularly the case for foam dispensers in which a spray nozzle and a filter arrangement such as the plug 210 or mesh screens have to be accommodated in the outlet passage. The presence of a projecting spout increases the tool space required to produce an actuator cap, which adds considerably to the costs of manufacture. In the field of mass produced dispensers, cost is of paramount importance. FIG. 23 illustrates a further embodiment 910 of a dispenser in which this problem is addressed.

The dispenser 910 in FIG. 23, is essentially the same as the dispenser 810 as shown in FIG. 21 except that the outlet passage 146 is located within the main body of the cap 114 above the first pump chamber 122 and the insert. The outlet passage 146 is fed from the first chamber 122 by a fluid flow passage 172 which enters the outlet passage through the rear end. An air flow passage also connects the secondary chamber 123 to the outlet passage 146 but is not shown in the drawings. Where the dispenser 910 is for use in a foam dispenser, a plug filter 210, 210′, 210″ or other filter arrangement can be located in the outlet passage 146 and the liquid introduced into the passage 146 by means of a spray or flood jet nozzle as discussed in relation to the embodiment shown in FIG. 20.

In the dispenser 910 as shown in FIG. 23, the entire outlet passage is located with the diametrical extent of the main body portion of the cap so that no projecting spout is required. This is ideal as it means that the tooling space required to mould the cap is kept to a minimum. However, in some cases it may only be possible to accommodate part of the outlet passage in the cap above the pump chambers so that a small spout will be required. This is still advantageous as the length of the spout is reduced, thus reducing the required tooling space. Nevertheless, it is preferred that at least 75% or more preferably 85% of the outlet passage 146 is located within the main body of the cap (that is to say within the diametrical extent of the cap).

The concept of locating all or the majority of the outlet passage 146 within the diametrical extent of the main body of the cap 114 in order to eliminate the need for a spout or to reduce the length of the spout can be applied to the design of any pump action or aerosol dispenser and is not limited to use with the embodiments disclosed in this application. Accordingly, patent protection for the arrangement may be sought independently of any other inventive concepts disclosed and/or claimed in this application.

Where dispensers in accordance with the invention are arranged to dispense two liquids, it may be desirable in some cases to keep the liquids separate so that they are only mixed when they leave the final outlet or near the outlet end of the outlet passage. This can be achieved by dividing the outlet passage 146 in two parts by means of a dividing wall and feeding the liquids from the two chambers in to the different parts or by providing two separate outlet passage for each liquid. The divided parts or the two outlet passages may be arranged one on top of the other or side by side. The divided or dual outlet passage could be formed in a spout or mainly located above the pump chambers within the diametrical extent of the cap as discussed above in relation to FIG. 23.

In the previously described embodiments, the insert 116 as been designed for use with a dip tube formed integrally with the container or which is a separate component. FIG. 24 illustrates how the insert 116 can be modified to incorporate an integral dip tube 180. This is advantageous as it means the insert and dip tube can be moulded together as a single integral component reducing manufacturing and assembly costs.

The insert 116 can also be modified to incorporate other features. In the embodiment shown in FIG. 25, rather than a dip tube 180, the insert includes an integral flexible bag 280 which can be filled with a liquid to be dispensed. In use, the bag is located within an outer container. An air bleed will allow atmospheric air to enter the container around the bag so that the bag collapses as liquid is drawn in the pump chamber 122. This arrangement is advantageous as it prevents liquid from leaking out between the container and the insert.

FIG. 26 shows an insert for use with a dispenser configured to dispense two different fluids. The insert 116 has an integral dip tube 180 which fluidly connects with the first pump chamber 122. The dip tube is surrounded by an integral flexible bag 280. As shown, the lower end of the bag is opened and in use the insert is inverted and the bag filled with a first liquid. The free end of the bag 280 is then sealed about the dip tube 180. The insert 116 is then located in a container which holds a second liquid. The second liquid is drawn into the first pump chamber 122 through the dip tube 180 whilst the first liquid is drawn from the bag into the secondary chamber 123 through a flow passage and one way valve which are not shown in the drawing. In this embodiment, the free end of the dip tube 180 is closed and a small slit is provided through with liquid enters the dip tube from the container. This enables a volume of liquid to be retained within the dip tube so that the dispenser can be actuated when inverted. The dip tube can be made larger than standard so that it can hold a sufficient volume of liquid for several actuations. This type of dip tube can be used in any of the embodiments disclosed.

As discussed previously, the insert 116 can be moulded from a material which remains resiliently flexible such as TPV, TPE, PP, silicon or the like or it can be manufactured from a combination of rigid and flexible materials using bi-injection moulding techniques. In the latter case, an integral dip tube could be formed from a rigid material and a flexible bag formed from a combination of flexible and rigid materials. For example, the side walls of the bag could be produced from a flexible material and the end from a rigid material. A bag or dip tube can also be shaped to improve its flexibility by being pleated or the like. Where more than one liquid is to be dispensed from a container, two or more integral dip tubes can be provided on an insert.

The insert 116 in the embodiments described above is a simple push fit in the neck 120 of the container 112. This arrangement is easy to manufacture and assemble. However, one potential drawback of this arrangement is the possibility of the insert pulling out of the neck if the dispenser is mistreated or subject to reduced or negative ambient pressure. Another problem is the need to prevent liquid leaking out between the insert and neck whilst allowing air to enter the container to prevent it collapsing as the liquid in the container is used up. These issues arise not only in respect of the insert 116 but apply to any pump dispenser arrangement which is a push fit in the neck of a container.

One method of preventing the insert or other push fit pump from being drawn out of the neck of a container is to use a collar which is mounted by means of a screw thread, or other suitable arrangement, on to the neck of the container to hold the insert 116 or other push fit pump in place. Where a twist lock arrangement is required to prevent unintentional actuation of the dispenser, corresponding formations for the twist lock can be provided on the collar and the actuator cap. Whilst a collar is effective in holding an insert or pump in position it does not specifically address the issue of preventing leakage whilst allowing air to enter the container and it requires the use of an additional component.

FIGS. 27 and 28 illustrate a further embodiment of a dispenser 1010 which has a modified twist lock arrangement designed to overcome the above mentioned potential problems.

In the dispenser 1010, the container 112 has a neck region 120 which includes a smaller diameter flange 282 projecting from the free end of the neck with an overhanging external lip 284 at the end of the flange. The lower diaphragm 186 of the insert 116 has an additional portion 286 that locates over collar and engages under the lip. A small ridge 288 extends about an outer diameter of the lower diaphragm. The side wall of the cap has a thickened lower section 289 and a ramp 290 between a thinner upper section 291 and the thickened lower section.

The free end of the side wall of the cap has an inwardly directed flange 138 which engages over a pair of spaced, generally circumferentially extending ridge formations 124 on the outer surface of the neck to prevent the cap from being separated from the container. The cap 114 is sufficiently flexible that the flange 138 can be pushed over the ridge formations 124 on assembly. Corresponding stops (not shown) on the neck 120 and cap 114 enable the cap to be rotated between a locked position and an unlocked position. In the locked position, further corresponding stops (not shown) on the neck and cap prevent the cap from being depressed to actuate the dispenser whereas in the unlocked position, the cap can be fully depressed. The ridge formations 124 on the neck are angled slightly so that the actuator cap 114 is moved axially in a downward direction relative to the neck 120 when it is moved to the unlocked position from the locked position.

When the cap 114 is in the upper locked position, the ridge 288 on the lower diaphragm is located opposite the lower thickened 289 region of the cap and the insert is pressed into contact with the lip to form an air and liquid tight seal. The flexible insert 116 is also firmly clamped in position in the container.

When the cap is moved to the unlocked position, it rotates the insert but also moves downwardly relative to the insert so that ridge 288 is located adjacent the ramp 290 or the thinner part of the cap wall 291. In this position, the flexible insert is no longer clamped to the lip 284 and air is able to pass along a channel 292 in the thicker wall section 289 of the cap and between the insert and the lip 284 as indicated by the arrow A in FIG. 28 to enter the container 112. A seal 186d on the insert contacts an inner surface of the container neck to prevent liquid from passing out but allows air to pass inwardly.

FIG. 28 shows the dispenser with the cap 114 in the locked position but the arrow A is included to show the flow path which is created when the cap is moved to the unlocked position.

The modified twist lock arrangement solves the problems of holding the insert 116 in position and preventing leakage without requiring the use of an additional component. This arrangement can be adopted for any suitable dispenser having a push fit pump arrangement and patent protection for this concept may be sought independently of any other inventive concepts disclosed and/or claimed in this application.

In all the embodiments described above, the cap 114 can be formed integrally with to the container but this is not essential and the container and cap can be formed separately. However, in certain applications it may be desirable to provide a pump dispenser separately from the container. Many advantages of the dispenser in accordance with the invention can still be achieved in this way. The insert 116 and cap 114 can be adapted to be mounted to a separate container having a suitably adapted neck region. Alternatively, an adaptor can be provided to enable the cap and insert to be mounted to a container having a standard neck region. In this case, the adaptor will form the base part 112 of the dispenser pump and will be comprise suitable means for mounting to the neck region of the container such as a screw thread or other twist fit arrangement, for example.

FIG. 29 illustrates an embodiment of a dispenser 1110 in which the actuator cap 114 is mounted to an adaptor 291 having a screw thread 291a for mounting to a container.

In some applications where there is no requirement to mix air with the liquid being dispensed it is possible to use both the first and second chambers to dispense the same liquid. This has the advantage of increasing the volume of liquid dispensed with each actuation. This can be done by providing separate inlets and outlets for each of the chambers as discussed previously. However, in this embodiment shown in FIG. 29, an alternative arrangement is used which requires only a single inlet and outlet for both chambers. This is achieved by use of a modified insert 116 which has openings 184j fluidly connecting the first and second chambers 122, 123. During the recovery phase after each actuation, liquid is drawn into the first chamber 122 through the inlet 185 is the usually way but the liquid flows through the openings 184j into the second chamber so that both chambers are filled. When the cap is depressed to actuate the dispenser, both chambers are compressed and the liquid flows from both chambers to the outlet.

Dispensers in accordance with the invention can be modified to incorporate a trigger actuator. This can be achieved by adding hinge formations to the neck region 120 of the container and providing a separate trigger actuator which is assembled to the hinge formations and which fits over the cap 114. The actuator may have an opening through which the outlet 144 projects.

Alternatively, the cap 114 can be modified to incorporate an integral trigger actuator as illustrated in FIG. 30. In this embodiment, the dispenser 1210 includes one or more hook like portions 196 moulded onto one side of the neck region 120 of the container. The cap 114 is provided with corresponding rod sections 198 which engage in the hooks 196 to form a hinge about which the cap 114 pivots. The cap 114 has a trigger portion 200 which can be gripped by a user to actuate the dispenser. In the embodiment shown in FIG. 30, the dispenser has only a single pump chamber which is formed between the upper diaphragm portion 184 of the insert and the collar 148 of the cap. However, any of the embodiments described in the present application can be modified to incorporate a trigger actuator, including the dispensers with two pump chambers.

FIGS. 31 to 33 illustrate an alternative embodiment of a dispenser 1310 in accordance with the invention which is adapted to incorporate a trigger actuator.

The dispenser 1310 comprises a container 300 having an open neck region 302, a dispenser cap 304 mounted to the container and an insert 306. The dispenser cap comprises a body having a cylindrical chamber portion 308, an outlet spout portion 310 and a neck engaging portion 312. The neck engaging portion is adapted to be a push fit on the open neck region 302 of the container and has an annular abutment 314 which engages in a groove 316 formed in the outer surface of the neck region to hold the cap firmly on the container.

The flexible insert or pump member 306 has a resiliently flexible upper diaphragm 184 which defines a first pump chamber 122 between itself and a domed upper wall 318 of the cap within the cylindrical chamber portion 308. A second, lower diaphragm or flange 186 of the insert seals against the side wall 320 of the cylindrical portion 308 of the cap to define a second chamber 123 between the side wall and the upper and lower diaphragms 184, 186. The insert 306 also includes a tubular portion 322 which connects the upper and lower diaphragms with a flexible cover 324 which mounts over and closes the open end of the neck of the container.

The cover 324 is in the form of a flexible inverted dome and has a flange 326 on its outer diameter which locates over the rim of the neck and is received in a recess 328 in the neck engaging portion of the cap so as to close and seal the neck region. A leak valve arrangement (not shown) is provided to enable air to enter the container as the liquid in the container is used up, to prevent the container from collapsing. The tubular portion 322 extends from a position above the lower diaphragm 186 into a central region of the cover 324 where it is in fluid communication which a dip tube 182 which extends into the container. The dip tube 182 may be a separate component or it may be formed integrally with the insert or integrally with the container.

The insert 306 is formed from a combination of flexible and rigid materials using bi-injection moulding techniques. The tubular portion 322 is formed from a substantially rigid material. An annular disc 330 of rigid material also projects outwardly from the tubular portion to provide a base for the lower diaphragm 186 and an actuation surface for contact by a trigger actuator 332. A first region of flexible material is over moulded on to an upper region of the tubular portion to define the upper and lower diaphragms 184, 186. The flexible material also forms a seal 334 for the lower diaphragm and various valve members for the chambers as will be described below. A further region of flexible material is over moulded on to the lower end of the tubular portion to define the cover 324.

At an upper end of the tubular portion 322, part of side wall is omitted and an inlet 336 into the second chamber 123 is formed through the flexible material as shown in FIG. 30. The inlet 336 is in the form of a slit which opens to admit liquid into the second chamber 123 when the pressure in the second chamber is below atmospheric but which is closed when the pressure in the chamber is above atmospheric so as to act as a one way inlet valve. Liquid can be drawn into the second chamber 123 from the container through the dip tube 182, the tubular portion 322 and the inlet 336.

The upper diaphragm 184 is held in position adjacent an upper end of the cylindrical chamber portion 308 by means of a flange 184d which locates in an annular recess or groove 154 in the cap, in a manner similar to the diaphragm 184 in the embodiment described above in relation to FIG. 21. The upper diaphragm also comprises an annular flexible valve member 184g which forms a ring valve to control the release of liquid from the second chamber 123 into an outlet passage 174. The valve member may be constructed in the manner described above in relation to the embodiment shown in FIG. 21.

An air inlet 338 for the first chamber 122 is provided in the upper wall 318. A resiliently flexible valve member 184j formed as an integral part of the upper diaphragm is positioned over the inner opening of the inlet 338 and acts as a one-way valve to admit air into the chamber when the pressure inside falls below atmospheric and to close the inlet when the dispenser is actuated and the pressure inside increases.

The dispenser 1310 is configured to produce a spray and the outlet includes a spray nozzle insert 340 with an atomising nozzle 342 which is mounted at the end of the outlet sprout 310. An air outlet passage 172 from the first chamber 122 passes through the centre of the outlet spout 310. A second insert 344 is located within the first insert 340 and forms an outlet for the air passage 172 to direct centrally into a swirl chamber 346 which is defined between the two inserts. The flow passage 174 from the second chamber 123 passes through the spout and is arranged to direct the liquid into the swirl chamber from the side. The liquid may be directed into the swirl chamber through a flood jet such as that shown in FIGS. 16a and 16b.

The trigger actuator 322 is pivotally mounted to the cap and comprises a trigger portion 348 and a curved actuating arm 350 that engages with the rigid disc 330 of the lower diaphragm 186. In use the trigger portion 348 is pulled towards the container and the main body of the dispenser, as shown in FIG. 33. This movement results in the curved actuating arm 350 pushing on the lower diaphragm 186 to move the insert 306 upwardly (as shown) relative the cap 304 to compress the first and second chambers, and so dispense a charge of liquid. The movement of the insert 306 is accommodated by the flexibility of the cover. When the trigger is released, resilience in the upper diaphragm 184 and/or the cover biases the insert back to the rest position as shown in FIG. 30. The curved actuator arm may be bifurcated so as to contact the lower diaphragm 186 on either side of the tubular portion.

As can be seen in FIG. 33, when the insert 306 is moved to its uppermost position, the upper diaphragm 184 conforms closely to the profile of the domed wall 318 so that very little dead space remains in the first chamber 122. The upper diaphragm also encases an upper region of the tubular portion so that very little dead space is left in the second chamber 123.

Mixing air with a liquid in a dispenser helps to improve the quality of the spray produced, particularly at the start and end of the spray cycle during which the pressure of the liquid flowing through the outlet nozzle is building up and falling away. It can also be useful to configure the dispenser so that air begins to flow from the air chamber through the nozzle before the liquid flow commences at the start of the spray cycle and that air continues to flow after the liquid has stopped at the end of the spray cycle.

Most prior art dispensers which incorporate an air chamber mix the air with the liquid at a substantially constant ratio throughout the spray cycle. This requires the air to be pressurised to the same pressure as the liquid during the whole of the spray cycle, including periods during the spray cycle when the pressure of the liquid passing through the outlet is at its peak. It also requires a relatively high volume of air meaning that a large air chamber is required. Because of these drawbacks and the additional manufacturing costs involved, air/liquid dispensers have not generally been adopted for mass market dispensers despite the known advantages of mixing air with liquid in terms of the quality of spray produced. However, the applicant has found that dispensers in accordance with the invention can be modified so that a higher ratio of air to liquid is delivered at the outlet nozzle during the initial and end phases of the spray cycle, where the air is most effective at improving the quality of the spray, and a reduced ratio of air to liquid delivered during the remainder of the spray cycle. This reduces the volume of air required which means that a smaller air chamber can be used. In many cases, air will only be delivered from the air chamber to the nozzle during the initial and end phases of the spray cycle where the pressure of liquid is less than its peak value so that the air in the air chamber does not have to be raised to the peak pressure of the liquid.

In order for the dispenser 1310 to deliver air to the nozzle before the liquid flow commences, it is necessary for the air chamber to be compressed before the outlet valve for the liquid chamber opens. However, because liquid is incompressible, this is not possible where one of the chambers is full of liquid. To overcome this problem in the present embodiment, a quantity of air is drawn into the second chamber 123 through the outlet nozzle during the recovery phase. A small bleed hole (not shown but typically in the order of 0.1 mm in diameter) is provided in the ring valve 184b through which the air can be admitted into the second chamber 123 from the nozzle as the insert recovers after each actuation. Typically, about 20% of the volume of the second chamber is taken up by air and the remainder by liquid drawn from the container but this can be varied as required.

The presence of air in the second chamber 123 enables the volume of second chamber to be reduced slightly before the outlet valve 184B opens. This in turn enables the insert 306 to move upwardly so that the volume of the first chamber is reduced and air begins to flow from the first chamber to the dispenser outlet 342. There is no outlet valve in the first chamber so that the air is delivered from the first chamber at a relatively low pressure which may be only just above atmospheric. Once the outlet valve 184b of the second chamber 123 opens, a mixture of air and liquid will flow along the passageway 174 to the swirl chamber 345 where it mixes with the air from the first chamber. Once the pressure of the liquid/air mix from the second chamber 123 in the passage 174 and the swirl chamber 345 rises, the flow of air from the first chamber is reduced so that over the main phase of the spray cycle, the majority of the air in the mixture passing through the nozzle 142 comes from the second chamber and the ratio of air to liquid in this phase is reduced. Towards the end of the spray cycle after the outlet valve 184b of the second chamber has closed, the pressure of the liquid/air mixture from the second chamber in the passage 174 and the swirl chamber 345 falls and air will again begin to flow from the first chamber 122 into the swirl chamber 345 where it mixes with the liquid/air mixture from the second chamber to improve the quality of the spray at the end of the cycle. The flow of air from the first chamber 122 at this stage also helps to draw all the liquid out of the outlet passage 174 of the second chamber. The dispenser is arranged so that air continues to flow from the first chamber for a short while after the flow of liquid has stopped to ensure all the liquid is dispensed and to clear our the nozzle 342.

In an alternative arrangement, a one way outlet valve (not shown) can be provided at the swirl chamber end of the outlet passage 172 from the air chamber. The air outlet valve is arranged to open at a lower pressure than the outlet valve of the liquid/air chamber 122 so that the air begins to flow before the liquid/air mix at the beginning of the spray cycle. Once the outlet valve of the second chamber opens, the pressure of the liquid/air mix from the second chamber flowing into the swirl chamber will act on the outside of the valve so as to close the air outlet passage once the pressure of the liquid/air mix increases beyond the pressure of the air in the first chamber. This will take place shortly after the spray cycle has begun. The valve will remain shut until the pressure of the liquid/air mixture from the second chamber falls below that of the air in the air chamber towards the end of the spray cycle. The air outlet valve will then re-open to allow air to flow from the air chamber 122 during the end phase of the spray cycle and for a short period after the flow of liquid through the nozzle has stopped.

By arranging the dispenser so that a higher ratio of air to liquid is delivered to the nozzle at the beginning and end of the spray cycle than during the remainder of the spray cycle, the quality of the spray can be maintained throughout using a lower volume of air than with previous known dispensers and the air need only be raised to a lower pressure which may be just above atmospheric. This means that a smaller volume air chamber can be used and the actuation forces can be kept low. By careful design of the flow rates of the liquid and air, it is possible to configure the dispenser so that it is able to deliver a continuous spray in excess of 1 second 1 The dispenser may include a spray nozzle and a trigger type actuator and may be configured to deliver a continuous spray for a period in excess of 1 second and more particularly, the dispenser may be configured to deliver a continuous spray for a period in the range of 1 to 10 seconds, and more particularly for a period of 4 to 10 seconds, and even more particularly for a period of 6 to 10 seconds.

A continuous spray is enabled in part by having a smaller than usual spray orifice to restrict the flow rate of the liquid being dispensed in combination with the addition of air, particularly at the beginning and end of the spray cycle, to ensure that the a good quality spray is produced. The presence of a pre-compression outlet valve from the liquid pump chamber or chambers is also advantageous as this ensures that spraying is commenced when the pressure of the liquid is sufficiently high to create a good quality spray. Ideally the pre-compression valve should be located close to the outlet nozzle to prevent liquid from continuing to flow from the outlet passage when the pressure of the liquid falls. To this end, a pre-compression outlet valve may be located in the outlet passage from the pump chamber to the spray nozzle close to the nozzle. The valve will be configured to only open to allow liquid to be dispensed when the pressure of the liquid at the valve is above a minimum pre-determined value to generate a spray in the particular application.

In some cases it may be desirable to have a mixture of air/liquid in both the chambers 122, 123 or the air could be pumped from the second chamber 123 and a liquid or liquid/air mixture pumped from the first chamber 122.

FIG. 34 illustrates an alternative embodiment of a dispenser 1410 which is configured to deliver a higher ratio of air to liquid during the initial and end phases of the spray cycle. The dispenser 1410 is of the type having a movable actuator cap 114 and is configured so that air is pumped from the second or outer chamber 123 and liquid is dispensed from the first or central upper, chamber 122. As noted previously, some air will also be present in the first liquid pump chamber because of the dead space in the chamber 122 which cannot be eliminated altogether. The presence of air in the first chamber 122 allows the insert 116 to deform slightly when the dispenser is actuated before the outlet valve from the first chamber opens so that the air in the second chamber is pressurised to a limited extent. In some cases, the dispenser can be modified to draw air into the first, liquid chamber when the insert recovers or other means may be used to enable the volume of the second chamber to be reduced before the liquid outlet valve opens.

The flow of liquid from the first chamber 122 is controlled by a ring valve 184b, which opens to admit liquid from the first chamber into an upper annular channel 154 from where it can flow along passages 172 into a swirl chamber 345 and through an outlet nozzle 342. The flow of air from the second chamber 123 is controlled by a ring valve 184g which admits air from the second chamber into a lower annular channel 350 from which it can also flow via suitable passageways into the swirl chamber 345. The upper and lower annular channels are fluidly connected so that liquid from the first chamber is also able to enter the lower annular channel when the outlet valve 184b of the first chamber 122 is open. The outlet valve 184g from the air chamber is configured to open at a lower pressure above ambient than the outlet valve 184b of the liquid chamber.

During actuation when the cap 114 is depressed, the outlet valve 184b of the air chamber 123 will open before the outlet valve 184b of the liquid chamber so that air initially flows through the outlet nozzle. Once the outlet valve 184b of the liquid chamber 122 opens, liquid will being to flow through the outlet to mix with the air from the second chamber in the swirl chamber. During this initial phase of the spray cycle, the pressure of the liquid flowing through outlet increases until it becomes higher than that of the air flowing from the air chamber and some liquid will flow into the lower annular chamber where it acts on and closes the outlet valve 184g of the second chamber. The air outlet valve 184b remains closed until near the end of the spray cycle when the pressure of the liquid in the outlet passageway falls below that of the air in the air chamber 123. The air outlet valve then re-opens so that air again flows through the outlet passageways to the nozzle 342 helping to drive all the remaining liquid in the outlet passageways through the outlet nozzle.

The valve arrangement shown in FIG. 34 can be adopted in a trigger actuated dispenser such as that shown in FIGS. 31 to 33 if desired or in any of the embodiments disclosed that have two pump chambers.

Rather then providing a mixture of air and liquid in at least one of the chambers, other arrangements can be used to enable the air chamber to be compressed before the outlet valve of the liquid chamber opens. For example, a compressible body can be located in the liquid chamber. Alternatively, the insert could be modified to have a compressible region to allow the air chamber to be compressed before the liquid chamber outlet valve is opened.

Dispensers in accordance with the invention are simple in construction and therefore relatively cheap to manufacture and yet highly effective. With all the flexible valve members for inlet and outlet valves of the or each chamber being formed integrally with the flexible insert, the dispenser comprises only three separate component parts, the cap, the base part (which may also comprises the container, and the insert. Where the cap and the base part are moulded together and interconnected by a lanyard, the dispenser will comprise only two separate component parts.

The flexible insert is a key element of the dispenser as it serves not only to define the pump chamber or chambers but also acts as a return spring. When the insert 116 is deformed, the core 176 is driven up into the upper diaphragm 184 which folds down about the core and, in some cases, a tapered region of the lower diaphragm. This helps to support the upper diaphragm and to stabilise the movement. Because the upper diaphragm is supported by the core, and in some cases the lower diaphragm, there is little or no lateral movement which prevents the actuator from wobbling when depressed. Deformation of the curved or angled resiliently deformable upper diaphragm 184 creates a restoring force tending to bias the insert back to its initial, resiliently biased rest position. The upper diaphragm 184 can be arranged so as to resist deformation until a certain actuation force is applied and to then deform relatively quickly giving a positive feel to the actuation for the user. The upper diaphragm 184 also recovers quickly once the actuation force is removed. It should also be noted that the upper diaphragm does not rely on co-operation with any rigid guide surfaces to generate a restoring force or to stabilize the movement and so is not subject to wear as a result of rubbing as may be the case with some known rolling diaphragm arrangements. In particular it should be noted that there are no other components located between the upper diaphragm and the core and/or the lower diaphragm when the insert is deformed.

As has been noted previously, the insert and the cap are shaped to minimise the dead space in the chamber or chambers when the inserted is fully deformed at the end of the spray cycle. Thus the upper diaphragm is curved or angled to conform closely to the shape of an upper wall defining part of the first chamber 122, the upper wall being correspondingly shaped. In some cases, the upper wall may have a recess to accommodate part of the inlet valve. The upper diaphragm 184 is also shaped so as to fold down around the core of the insert and/or to overlie angled surfaces of the lower diaphragm 186 to minimise the dead space on the second chamber 123 when present.

In addition, the same basic design can be modified to provide a range of pumps. Thus the same cap 114 and base parts 112 can be used to form a single chamber pump or a dual chamber pump by using a modified flexible insert 116. The outlet 144, 144′ of the cap can be moulded by means of an insert in the mould tool which is interchangeable so that the same basic tool can be used to produce cap actuators 114 having different outlet arrangements, e.g. spray nozzle, foam dispenser etc. In addition, a range of pump sizes can be produced by modifying the insert 116 and actuator cap 114. Alternatively, the discharge volume of the dispenser can be changed by providing cooperating stops on the cap 114 and the base part 112 to limit the range of movement of the cap 114 relative to the base part 112 to less than its potential maximum range of movement. The position of the stops can be varied to provide range of pumps having different discharge volumes but using the same basic cap 114, base part 112 and insert 116. The stops can be produced by means of inserts on the mould tool thus enabling a range of pumps to be manufactured using the same basic tooling. All of this enables a new pump range to be brought to market with significantly reduced tooling costs when compared to the prior art in which separate tooling is required for each pump size and type.

Whereas the invention has been described in relation to what is presently considered to be the most practical and preferred embodiments, it is to be understood that the invention is not limited to the disclosed arrangements but rather is intended to cover various modifications and equivalent constructions included within the spirit and scope of the invention. For example, the flexible insert 116 can be configured to extend over the outside of the neck 120 in some cases. In some embodiments the dispenser may be adapted to work upside down. In such arrangements, the dispenser may not have a dip tube. Instead, the liquid to be dispenses will be contained in a flexible bag having an outlet in fluid connection with the inlet to the first pump chamber. Where two liquids are to be dispensed, the two liquids can each be held in a flexible bag having an outlet in fluid connection with a respective pump chamber.

1. A manual pump dispenser for dispensing a fluid, the dispenser comprising a base and a dispensing cap having a dispenser outlet mounted to the base, the dispenser further comprising an insert mountable between the base and the cap to define at least one pump chamber between itself and the cap, the insert being adapted to engage with the base to define an inlet through which a liquid can be drawn into the at least one pump chamber from a liquid source, in which the insert comprises a central core and a resiliently flexible upper diaphragm member projecting upwardly and generally radially outwardly from the core for contact with the cap to at least partially define the at least one pump chamber within the cap, the insert being movable between an initial resiliently biased configuration in which the volume of the at least one pump chamber is at a maximum and a deformed configuration in which the volume of the at least one pump chamber is at a minimum, in the deformed configuration, the upper diaphragm being at least partially folded down about itself and/or the core.

2. A manual pump dispenser as claimed in claim 1, in which the cap comprises a shaped upper wall which defines part of a pump chamber in combination with the upper diaphragm, the upper diaphragm being configured such that when it is in the deformed configuration it conforms closely to the shape of the upper wall.

3. A manual pump dispenser as claimed in claim 2, in which the upper wall of the cap is domed and the upper diaphragm curves upwardly and generally radially outwardly from the central core.

4. A manual pump dispenser as claimed in claim 2, in which the upper wall of the cap comprises a frusto-conical region and the upper diaphragm comprises a corresponding frusto-conical region which extends upwardly and generally radially outwardly from the core.

5. A manual pump dispenser as claimed in any one of claims 1 to 4, in which the dispenser comprises a trigger actuator, the actuator being engageable with the insert to move the insert within the cap from the from its initial resiliently biased configuration to its deformed configuration.

6. A manual pump dispenser as claimed in claim 5, in which the insert comprises a lower diaphragm member projecting generally radially outwardly from the core below the upper diaphragm and a flexible member for mounting to the base to define the inlet, the trigger actuator being configured to engage the lower diaphragm member and the flexible member being configured to accommodate movement of the insert relative to the base.

7. A manual pump dispenser as claimed in claim 6, in which the core projects below the lower diaphragm and the flexible member is located on a lower end of the core.

8. A manual pump dispenser as claimed in claim 7, in which the insert is moulded from a combination of relatively rigid and relatively flexibly polymeric materials, at least part of the core being formed from a relatively rigid material, the upper and lower diaphragms and the flexible member being formed from one or more relatively flexible polymeric materials over moulded onto the core.

9. A manual pump dispenser as claimed in any one of claims 1 to 8, in which the insert comprises an integral dip tube.

10. A manual pump dispenser as claimed in any one of claims 1 to 9, in which the insert comprises an integral bag for containing a liquid.

11. A manual pump dispenser as claimed in any one of claims 1 to 10, in which the base is part of a container for a liquid to be dispensed.

12. A manual pump dispenser as claimed in claim 11, in which the base comprises a neck region of the container.

13. A manual pump dispenser as claimed in any one of claims 1 to 10, in which the base is adapted to be mounted to the neck region of a container for a liquid to be dispensed.

14. A manual pump dispenser as claimed in any one of the previous claims, in which a fluid passage is defined through the core along which liquid can flow to enter the at least one pump chamber from a liquid source.

15. A manual pump dispenser as claimed in claim 14, in which a one way inlet valve is formed integrally as part of the insert to admit liquid into the at least one pump chamber from the fluid passage when the pressure in the pump chamber is below the pressure of the liquid in the passageway.

16. A manual pump dispenser as claimed in any one of the previous claims, the insert having a lower diaphragm member projecting generally radially outwardly from the core for contact with the cap to at least partially define a pump chamber within the cap between itself and the upper diaphragm member, such that the volume of the pump chamber is at a maximum when the insert is in the initial configuration and at a minimum when the insert is in the deformed configuration.

17. A manual pump dispenser as in claim 16, in which the insert defines at least two pump chambers inside the cap, a first pump chamber being defined between the upper diaphragm member and a closed upper end region of the cap and a second pump chamber being defined between the upper and lower diaphragm members and a side wall region of the cap, one of the first and second chambers comprising the at least one pump chamber and the other of the first and second chambers comprising a further pump chamber, the cap having an outlet passage arrangement for fluidly connecting each of the two pump chambers with the dispenser outlet.

18. A manual pump dispenser as claimed in claim 17, the dispenser including an air inlet arrangement by means of which ambient air can be drawn into the further chamber when the insert recovers from its deformed configuration to its initial configuration.

19. A manual pump dispenser arrangement as claimed in claim 17 or claim 18, in which the outlet passage arrangement includes a first outlet passage for connecting the at least one pump chamber with the dispenser outlet and a second outlet passage for connecting the further pump chamber with the dispenser outlet.

20. A manual pump dispenser as claimed in claim 19, in which the first and second outlet passages are joined together upstream of the dispenser outlet so that, in use, the fluid from the further chamber and liquid from the at least one chamber are caused to mix before passing through the dispenser outlet.

21. A manual pump dispenser as claimed in claim 20, in which the first and second outlet passages are joined at a swirl chamber upstream from the dispenser outlet.

22. A manual pump dispenser as claimed in any one of claims 19 to 21 when dependent on claim 18, in which the dispenser comprises a pre-compression valve for controlling the flow of liquid through the first outlet passage, the pre-compression valve being configured to open to allow liquid to flow from the at least one pump chamber to the dispenser outlet only when the pressure of the liquid in the at least one pump chamber is at or above a pre-determined threshold value, the outlet arrangement being arranged such that in use, the ratio of air to liquid dispensed varies over the course of a spray cycle.

23. A manual pump dispenser as claimed in claim 22, in which the outlet arrangement is arranged such that the ratio of air to liquid dispensed is higher during at least one of an initial and an end phase of the spray cycle than during a main phase of the spray cycle.

24. A manual pump dispenser as claimed in claim 23, in which outlet arrangement is arranged such that the ratio of air to liquid dispensed is higher during both the initial and end phases of the spray cycle than during a main phase.

25. A manual pump dispenser as claimed in any one of claims 22 to 24, in which the first and second outlet passages are fluidly connected so that in use the pressure of the liquid flowing from the at least one pump chamber to the dispenser outlet limits the flow of air from the further pump chamber to the dispenser outlet.

26. A manual pump dispenser as claimed in claim 25, in which no-pre-compression valve is provided to control the flow of air from further pump chamber to the dispenser outlet.

27. A manual pump dispenser as claimed in any one of claims 22 to 26, in which a one-way valve is provided to prevent liquid flowing along the second outlet passage into the further pump chamber.

28. A manual pump dispenser as claimed in any one of claims 17 to 27, in which the dispenser includes an air inlet arrangement for drawing a quantity of ambient air into the at least one pump chamber when the insert recovers from its deformed configuration to its initial configuration.

29. A manual pump dispenser as claimed in any one of the previous claims, in which the dispenser outlet comprises a nozzle adapted so that liquid dispensed through the nozzle under pressure forms a spray.

30. A pump dispenser as claimed in claim 29 when dependent on any one of claims 22 to 27, in which the dispenser includes a trigger type actuator and is configured to deliver a continuous spray for a period in excess of 1 second, and more particularly for a period in the range of 1 to 10 seconds, or 4 to 10 seconds, or 6 to 10 seconds.

31. A manual pump dispenser as claimed in any one of the previous claims, in which an outlet passage connecting the at least one pump chamber with the dispenser outlet is defined within the cap, the insert having an integral, resiliently flexible valve member which is resiliently biased into contact with a surface of the cap to prevent liquid flowing along the outlet passage to the dispenser outlet, the flexible valve member comprising a resiliently deformable flap having an enlarged end region for contact with the surface of the cap.

32. A manual pump dispenser as claimed in claim 31, in which the portion of the enlarged end region which contacts the surface of the cap has a curved outer profile.

33. A manual pump dispenser as claimed in claim 32, in which the cap comprises two spaced wall members which define between them an annular channel forming part of the outlet passage, the enlarged end region of the flexible valve member being resiliently biased into engagement with one of the wall members.

34. A manual pump dispenser as clamed in claim 33, in which an outlet for the at least one pump chamber is defined in the cap to fluidly connect the at least one pump chamber with the annular passage on one side of the valve member such that, in use, the pressure of the liquid in the at least one pump chamber and the outlet when the dispenser is actuated reacts against the valve member tending to move the valve member against the resilient bias force so that the enlarged end is displaced away from the surface to open a flow path to the dispenser outlet, the arrangement being such that the valve member is only moved sufficiently to open a flow path when the pressure of the liquid in the at least one pump chamber and the outlet is at or above a threshold value.

35. A manual pump dispenser as claimed in any one of claims 31 to 34, in which the enlarged end region is resiliently compressible, the valve member being configured so that the enlarged end region is compressed against the surface when the valve member is in a fully engaged position.

36. A manual pump dispenser as claimed in claim 35 when dependent on claim 34, in which, in use, the valve flap can be moved from the fully engaged position in a direction away from the surface by a distance before the enlarged end region loses contact with the surface to open the flow path.

37. A manual pump dispenser as claimed in any one of claims 31 to 36, in which the valve member is annular.

38. A manual pump dispenser as claimed in any one of the previous claims, in which the base is annular and comprises or is adapted to be mounted to an annular neck forming an outlet of a container for a liquid to be dispensed, the insert having a second diaphragm member which projects generally radially outwardly from the core, the second diaphragm member including an integral, resiliently flexible inner seal which is resiliently biased against an inner surface of the base to form a liquid tight seal to prevent liquid from leaking out of the base past the insert in use, the inner seal member being capable of being deflected away from the inner surface of the base permit air to flow in an inward direction past the inner seal when the pressure of the ambient air acting on an outer side of the inner seal is greater than the pressure acting on the inner side of the inner seal member by a threshold amount in use, the second diaphragm member including an outer seal member which locates about an outer surface of the base, the dispenser having a twist lock arrangement operative such that the cap can be twisted relative to the base between a locked position in which actuation of the dispenser is disabled and a released position in which the dispenser can be actuated, the cap and the base having corresponding formations which co-operate to move the cap axially relative to the base when it is twisted between the locked and released positions, the cap having a further formation which compresses the outer seal member against the outer surface of the base to form a liquid and air tight seal between the outer seal member and the base when the cap is in the locked position, the air tight seal being released when the cap is in the unlocked position.

39. A manual pump dispenser as claimed in claim 38, in which the base has a flange portion of reduced outer diameter at one end, the outer seal engaging with an outer diameter surface of the flange portion.

40. A manual pump dispenser as claimed in claim 39, in which the outer surface of the flange comprises an under cut lip, the outer seal member having an annular lip on its inner surface which engages in the undercut.

41. A manual pump dispenser as claimed in any one of claims 38 to 40, in which the cap has an annular wall member which surrounds the outer seal member and the further formation comprises a region of the annular wall of increased thickness.

42. A manual pump dispenser as claimed in any one of claims 38 to 41, in which a ridge is provided about an outer surface of the outer seal member which is contacted by the further formation.

43. A manual pump dispenser as claimed in any one of the previous claims, in which the dispenser is adapted to dispense a liquid as a foam, the cap defining an outlet passage arrangement fluidly connecting the at least one pump chamber to the dispenser outlet, the passage arrangement comprising an inlet for directing the liquid from one part of the outlet passage arrangement into an expansion chamber forming a further part of the passage arrangement, the expansion chamber having a larger cross-sectional area than the inlet, in which the inlet is configured so that the liquid is formed into a thin sheet or fan on entry into the expansion chamber.

44. A manual pump dispenser as claimed in claim 43, in which the inlet comprises at least one orifice for directing the liquid into the expansion chamber and at least one corresponding formation on to which the liquid passing through the orifice is directed inside the expansion chamber, the formation being shaped to deflect the liquid through an angle in the range of 60° to 120°, and more preferably in the range of 80° to 110°, from its direction of travel through the orifice.

45. A manual pump dispenser as claimed in claim 44, in which the formation comprises a curved ramp surface.

46. A manual pump dispenser as claimed in claim 45, in which the ramp surface is textured.

47. A manual pump dispenser as claimed in claim 45 or claim 46, in which the ramp surface comprises defines a curved channel.

48. A manual pump dispenser as claimed in any one of claims 44 to 47, in which the formation is flexible so that it is capable of movement under the pressure of the liquid being directed on to it in use.

49. A manual pump chamber as claimed in any one of claims 44 to 47, in which the expansion chamber is in the form of an elongate fluid passage and the orifice directs the liquid into the expansion chamber in a lateral direction of the chamber.

50. A manual pump chamber as claimed in any one of claims 44 to 47, in which the expansion chamber is in the form of an elongate fluid passage and the orifice directs the liquid into the expansion chamber in an axial direction of the chamber.

51. A manual pump chamber as claimed in claim 43, in which the inlet comprises an inlet fluid passage for directing the liquid into the expansion chamber, the inlet fluid passage having a conically divergent outlet region, the inlet further comprising a flow divider located centrally in the outlet region, such that a frusto-conical fluid channel is defined between the flow divider and the surface of the divergent region of the inlet fluid passage.

52. A manual pump dispenser as claimed in claim 51, in which the flow divider has a conical region which locates within the divergent region, the outer surface of the conical region of the flow divider being spaced from the surface of the divergent region of the inlet fluid passage.

53. A manual pump dispenser as claimed in claim 51 or claim 52, in which the flow divider is suspended within the inlet fluid passage by means of two or more links, the links being spaced so that fluid flow channels are provided between the links through which the liquid flowing through the frusto-conical fluid channel can pass.

54. A manual pump chamber as claimed in claim 53, in which the flow divider is an integral part of the cap.

55. A manual pump dispenser as claimed in any one of claims 43 to 54, in which filter means are provided in the expansion chamber to refine foam produced in the expansion chamber.

56. A manual pump dispenser as claimed in claim 55, in which the filter means comprises two or more spaced mesh screens.

57. A manual pump dispenser as claimed in any one of claims 43 to 56, in which the insert defines at least one further pump chamber in the cap, the at least one further pump chamber being configured to dispense air, the cap defining an air outlet passage arrangement for directing air from the further pump chamber into the expansion chamber to mix with the liquid.

58. A manual pump dispenser as claimed in claim 57, when dependent on claim 49 or claim 50, in which the air outlet passage arrangement comprises one or more orifices for directing air into the expansion chamber in a longitudinal or axial direction of the chamber.

59. A manual pump dispenser for dispensing a liquid product, the dispenser comprising a pump chamber for receiving the liquid product from a liquid source and an outlet through which the liquid product is dispensed from the pump chamber, the dispenser further comprising a reservoir for holding a volume of water and means for introducing water from the reservoir into the liquid product in at least one of the pump chamber and an outlet passage connecting the pump chamber with the outlet.

60. A manual pump dispenser as claimed in claim 59, in which the reservoir has a removable closure to enable the reservoir to be periodically re-filled.

61. A manual pump dispenser comprising a container for a liquid to be dispensed, the container having an annular neck forming an outlet for the container, a pump arrangement including at least one pump chamber mounted to the container for dispensing the liquid in the container, the dispenser also comprising a closure member mounted to and closing the neck of the container, the closure member having a resiliently flexible inner seal which is resiliently biased against an inner surface of the neck to form a liquid tight seal to prevent liquid from leaking out of the container, the inner seal being capable of being deflected away from the inner surface of the neck to permit air to flow in an inward direction past the inner seal when the pressure inside the container is lower than the pressure of the ambient air acting on the inner seal by a threshold amount in use, the closure member including an outer seal which locates about an outer surface of the neck, the dispenser having collar, at least part of which locates about the neck of the container, and a twist lock arrangement operative such that the collar can be twisted relative to the neck between a locked position in which actuation of the dispenser is disabled and a released position in which the dispenser can be actuated, the collar and the container having corresponding formations which co-operate to move the collar axially relative to the neck when it is twisted between the locked and released positions, the collar having a further formation which compresses the outer seal member against the outer surface of the neck to form a liquid and air tight seal between the outer seal and the neck when the collar is in the locked position, the air tight seal being released when the collar is in the unlocked position.

62. A manual pump dispenser as claimed in claim 61, in which the neck comprises a flange portion of reduced outer diameter, the outer seal engaging with an outer surface of the flange portion.

63. A manual pump dispenser as claimed in claim 62, in which the outer surface of the flange comprises an under cut lip, the outer seal having an annular lip on its inner surface which engages in the undercut.

64. A manual pump dispenser as claimed in any one of claims 61 to 63, in which the collar has an annular wall member which surrounds the outer seal and the further formation comprises a region of the wall of increased thickness.

65. A manual pump dispenser as claimed in any one of claims 61 to 64, in which a ridge is provided about an outer surface of the outer seal which is contacted by the further formation.

66. A manual pump dispenser as claimed in any one of claims 61 to 65, in which the collar comprises part of an actuation cap of the dispenser pump arrangement.

67. A manual pump dispenser for dispensing a liquid as a foam, the dispenser having a dispenser outlet, at least one pump mechanism including a pump chamber, and an outlet passage arrangement fluidly connecting the pump chamber to the dispenser outlet, the pump mechanism being operative to draw a liquid from a liquid reservoir into the pump chamber and to dispense the liquid from the chamber into the outlet passage arrangement under pressure when actuated, the outlet passage arrangement comprising an inlet through which the liquid product is directed from one part of the outlet passage arrangement into an expansion chamber forming a further part of the passage arrangement, the expansion chamber having a larger cross-sectional area than the inlet, in which the inlet is configured so that the liquid passing through the inlet in use is formed into a thin sheet on entry into the expansion chamber.

68. A manual pump dispenser as claimed in claim 67, in which the inlet comprises at least one orifice through which the liquid is directed into the expansion chamber and at least one corresponding formation on to which liquid passing through the orifice is directed inside the expansion chamber, the formation being shaped to deflect the liquid through an angle in the range of 60° to 120°, and more preferably in the range of 80° to 110°, from its direction of travel through the orifice.

69. A manual pump dispenser as claimed in claim 68, in which the formation comprises a curved ramp surface.

70. A manual pump dispenser as claimed in claim 69, in which the ramp surface is textured.

71. A manual pump dispenser as claimed in claim 69 or claim 70, in which the ramp surface comprises defines a curved channel.

72. A manual pump dispenser as claimed in any one of claims 68 to 71, in which the formation is flexible so that it is capable of movement under the pressure of the liquid being directed on to it in use.

73. A manual pump chamber as claimed in any one of claims 68 to 72, in which the expansion chamber is in the form of an elongate fluid passage and the orifice directs the liquid into the expansion chamber in a lateral direction of the chamber.

74. A manual pump chamber as claimed in any one of claims 68 to 72, in which the expansion chamber is in the form of an elongate fluid passage and the orifice directs the liquid into the expansion chamber in an axial direction of the chamber.

75. A manual pump chamber as claimed in claim 67, in which the inlet comprises an inlet fluid passage for directing the liquid into the expansion chamber, the inlet fluid passage having a conically divergent outlet region, the inlet further comprising a flow divider located centrally in the outlet region, such that a frusto-conical fluid channel is defined between the flow divider and the surface of the divergent region of the inlet fluid passage.

76. A manual pump dispenser as claimed in claim 75, in which the flow divider has a conical region which locates within the divergent region, the outer surface of the conical region of the flow divider being spaced from the surface of the divergent region of the inlet fluid passage.

77. A manual pump dispenser as claimed in claim 75 or claim 76, in which the flow divider is suspended within the inlet fluid passage by means of two or more links, the links being spaced so that fluid flow channels are provided between the links through which the liquid flowing through the frusto-conical fluid channel can pass.

78. A manual pump chamber as claimed in any one of claims 75 to 77, in which the flow divider is an integral part of the cap.

79. A manual pump dispenser as claimed in any one of claims 67 to 78, in which a filter arrangement is provided in the expansion chamber to refine foam produced in the expansion chamber.

80. A manual pump dispenser as claimed in claim 79, in which the filter arrangement comprises two or more spaced mesh screens.

81. A manual pump dispenser as claimed in any one of claims 67 to 80, in which the pump mechanism comprises at least one further pump chamber for dispensing air, the outlet passage arrangement including an air outlet passage arrangement for directing air from the further pump chamber into the expansion chamber to mix with the liquid.

82. A manual pump dispenser as claimed in claim 81, when dependent on claim 73 or claim 74, in which the air outlet passage arrangement comprises one or more orifices for directing air into the expansion chamber in an axial direction of the chamber.

83. A manual pump dispenser comprising a pump chamber having an outlet, a dispenser outlet and a outlet passage connecting the pump chamber outlet with the dispenser outlet, the dispenser comprising a valve member for controlling the flow of liquid from the pump chamber outlet to the dispenser outlet, the valve member being resiliently biased into contact with a surface of the dispenser to prevent liquid flowing along the outlet passage to the dispenser outlet, in which the valve member comprises a resiliently deformable flap having an enlarged end region for contact with the surface.

84. A manual pump dispenser as claimed in claim 83, in which the portion of the enlarged end region which contacts the surface has a curved outer profile.

85. A manual pump dispenser as claimed in claim 84, in which the dispenser comprises two spaced wall members which define between them an annular channel forming part of the outlet passage, the enlarged end region of the flexible valve member being resiliently biased into engagement with one of the wall members.

86. A manual pump dispenser as clamed in claim 85, in which the pump chamber outlet fluidly connects the pump chamber with the annular passage on one side of the valve member such that, in use, the pressure of the liquid in the pump chamber and the outlet when the dispenser is actuated reacts against the valve member tending to move the valve member against the resilient bias force so that the enlarged end is displaced away from the surface to open a flow path to the dispenser outlet, the arrangement being such that the valve member is only moved sufficiently to open a flow path when the pressure of the liquid in the pump chamber and the outlet is at or above a threshold value.

87. A manual pump dispenser as claimed in any one of claims 83 to 86, in which the enlarged end region is resiliently compressible, the valve member being configured so that the enlarged end region is compressed against the surface when the valve member is in a fully engaged position.

88. A manual pump dispenser as claimed in claim 87 when dependent on claim 86, in which, in use, the valve flap can be moved from the fully engaged position in a direction away from the surface by a distance before the enlarged end region loses contact with the surface to open the flow path.

89. A manual pump dispenser as claimed in any one of claims 83 to 88, in which the valve member is annular.

90. A manual pump dispenser, the dispenser having a body comprising a base defining an outlet through which a liquid to be dispensed may be drawn from a liquid source and a dispenser cap mounted to the base, the dispenser cap having a dispenser outlet and defining a bore, the dispenser further comprising a pump member located in the bore to define at least two pump chambers within the cap, the pump member comprising a central core and having a closure member mounted to the base to close the outlet, the pump member having a resiliently flexible first diaphragm member projecting from the core for contact with the cap, a first pump chamber being defined between the first diaphragm member the cap and an end region of the cap, the pump member having a seal member projecting from the core in spaced relation to the first diaphragm member and the closure member, the seal member contacting a surface of the cap defining the bore, a second pump chamber being defined within the cap between the first diaphragm member and the seal member, the pump member being movable relative to the cap between an initial resiliently biased configuration in which the volume of the two pump chambers is at a maximum and a deformed configuration in which the volume of the two pump chambers is reduced, the dispenser further comprising a trigger actuator mounted to the body for movement between a released position and an actuated position, the trigger actuator having an abutment formation which contacts a corresponding abutment formation on the pump member to move the pump member from the initial resiliently biased configuration to the deformed configuration on movement of the trigger from the released position to the actuated position.

91. A manual pump dispenser as claimed in claim 90, in which the base is adapted to be mounted to an outlet of a container for a liquid to be dispensed.

92. A manual pump chamber as claimed in claim 90, in which the base comprises a container for a liquid to be dispensed, the container having an annular neck region which defines the outlet, the cap being mounted to the container about the neck region.

93. A manual pump dispenser as claimed in any one of claims 90 to 92, in which a fluid passage arrangement is defined within the core and for fluidly connecting at least one of the first and second pump chambers with a liquid source, the fluid passage arrangement having an inlet for fluid connection with a liquid source through the outlet.

94. A manual pump dispenser as claimed in claim 93, in which the fluid passage arrangement is configured to fluidly connect the inlet to both the first and second pump chambers.

95. A manual pump dispenser as claimed in claim 93, in which the fluid passage arrangement comprises separate fluid passageways for fluidly connecting each of the first and second pump chambers with a liquid source, each fluid passageway having an inlet for fluid connection with a liquid source through the outlet.

96. A manual pump dispenser as claimed in any one of claims 90 to 95, in which the corresponding abutment formation on the pump member comprises a rigid abutment surface projecting outwardly from core between the first diaphragm member and the closure member, the trigger having one or more projections for contact with rigid abutment surface.

97. A manual pump dispenser as claimed in claim 96, in which the seal member is located about the rigid abutment surface.

98. A manual pump dispenser as claimed in any one of claims 90 to 97, in which the closure member is flexible to accommodate movement of the pump member between the initial resiliently biased configuration and the deformed configuration.

99. A manual pump dispenser as claimed in any one of claims 90 to 98, in which at least part of the core between the closure member and the corresponding abutment formation is flexible to accommodate movement of the pump member between the initial resiliently biased configuration and the deformed configuration.

100. A manual pump dispenser as claimed in any one of claims 90 to 99, in which the pump member has a rigid portion which defines at least part of the core and the corresponding abutment formation and resiliently flexible portions which define the first diaphragm member, the seal member and the closure member.

101. A manual pump dispenser as claimed in any one of claims 90 to 100, in which the dispenser comprises an inlet arrangement including an inlet valve for admitting ambient air in to at least one of the pump chambers when the pressure in the chamber is below ambient air pressure by a predetermined amount.

102. A manual pump dispenser as claimed in any one of claims 90 to 101, in which the dispenser is configured to dispense a liquid as foam, the dispenser including an outlet passageway arrangement as claimed in any one of claims 67 to 82.

103. A manual pump dispenser as claimed in claim 101, in which the cap comprises an outlet fluid passageway arrangement for fluidly connecting the first and second pump chambers with the dispenser outlet, the outlet passage arrangement including a first outlet passage for connecting the first pump chamber with the dispenser outlet and a second outlet passage for connecting the second pump chamber with the dispenser outlet.

104. A manual pump dispenser as claimed in claim 103, in which the first and second outlet passages are joined together upstream of the dispenser outlet so that, in use, the fluids dispensed from the first and second pump chambers are caused to mix before passing through the dispenser outlet.

105. A manual pump dispenser as claimed in claim 104, in which the first and second outlet passages are joined at a swirl chamber upstream from the dispenser outlet.

106. A manual pump dispenser as claimed in claim 104 or claim 105, in which one of the pump chambers is configured to dispense a liquid and the other air, the dispenser having an outlet arrangement having a spray nozzle and a pre-compression valve for controlling the flow of liquid from said one of the chambers, the pre-compression valve being configured to open to allow liquid to flow from said one of the pump chambers to the dispenser outlet only when the pressure of the liquid in said one of the pump chambers is at or above a pre-determined threshold value, the outlet arrangement being arranged such that in use, the ratio of air to liquid dispensed varies over the course of an actuation cycle.

107. A manual pump dispenser as claimed in claim 106, in which the outlet arrangement is arranged such that the ratio of air to liquid dispensed is higher during at least one of an initial and an end phase of the spray cycle than during a main phase of the spray cycle.

108. A manual pump dispenser as claimed in claim 107, in which outlet arrangement is arranged such that the ratio of air to liquid dispensed is higher during both the initial and end phases of the spray cycle than during a main phase.

109. A manual pump dispenser as claimed in any one of claims 106 to 108, in which the first and second outlet passages are fluidly connected so that in use the pressure of the liquid flowing from said one of the pump chambers to the dispenser outlet limits the flow of air from the other of the pump chambers to the dispenser outlet.

110. A manual pump dispenser as claimed in claim 109, in which no-pre-compression valve is provided to control the flow of air from the other of the pump chambers to the dispenser outlet.

111. A manual pump dispenser as claimed in any one of claims 106 to 110, in which a one-way valve is provided to prevent liquid flowing from said one of the pump chambers to the other of the pump chambers.

112. A pump dispenser as claimed in any one of claims 106 to 111, in which the dispenser is configured to deliver a continuous spray for a period in excess of 1 second and more particularly for a period in the range of 1 to 10 seconds, or 4 to 10 seconds, or 6 to 10 seconds.

113. A manual pump dispenser as claimed in any one of claims 90 to 112, in which the dispenser comprises a pre-compression outlet valve arrangement as claimed in any one of claims 83 to 89.

114. A manual pump dispenser as claimed in any one of claims 1 to 4 or any one of claims 9 to 89, in which the dispenser has a trigger actuator.

115. A manual pump dispenser in which the trigger actuator is provided as an integral part of the cap.

116. A manual pump dispenser as claimed in claim 114 when dependent on any one of claims 1 to 4 or 9 to 58, in which the trigger actuator is operatively connected such that movement of the trigger towards a central longitudinal axis of the dispenser moves the insert from its initial resiliently biased configuration to its deformed configuration.

117. A manual pump chamber as claimed in claim 114 or claim 115, in which the dispenser is a foam dispenser.

118. A manual dispenser as claimed in claim 114 or claim 115, in which the dispenser is a spray dispenser.

119. A manual pump dispenser substantially as herein before described, with reference to an as illustrated in the accompanying Figures.
